(19) United States
(12) Patent Application Publication
(10) Pub. No.: US 2017/0251713 A1
(43) Pub. Date: Sep. 7, 2017

(54) 3D PRINTER AND METHOD FOR PRINTING AN OBJECT USING A CURABLE LIQUID

(71) Applicant: Telamens, Inc., Los Alamos, NM (US)

(72) Inventors: Benjamin P. Warner, Los Alamos, NM (US); Francesco de Rege Thesauro, Acton, NM (US)

(73) Assignee: Telamens, Inc., Los Alamos, NM (US)

(21) Appl. No.: 15/440,659

(22) Filed: Feb. 23, 2017

Related U.S. Application Data
(60) Provisional application No. 62/304,366, filed on Mar. 7, 2016.
(60) Provisional application No. 62/304,371, filed on Mar. 7, 2016.

(51) Int. Cl. A23P 20/25; B33Y 70/00; A23L 3/00; B29C 67/00; B33Y 50/02; A23P 30/20; B33Y 10/00; B33Y 80/00

(52) U.S. Cl. CPC A23P 20/25; B33Y 10/00; B33Y 70/00; B33Y 80/00; B29C 67/0092; B29C 67/0055; B29C 67/0088; B33Y 50/02; A23P 30/20; A23L 3/00; B29K 2063/00

(57) ABSTRACT

Additive manufacturing methods and apparatus are described for the productions of parts using feedstocks that are cured. The parts are produced in a layer-by-layer fashion by forming in situ a container, filling the container with a liquid and curing the liquid.

### RELATED APPLICATIONS/CLAIM OF PRIORITY

This application claims priority from U.S. provisional application Ser. No. 62/304,366 filed Mar. 7, 2016 and 62/304,371 filed Mar. 7, 2016. The forgoing applications are incorporated by reference herein.

### FIELD OF THE DISCLOSURE

The present disclosure relates generally to additive manufacturing. More particularly this disclosure relates to 3D printing a 3D printed container and filling the container.

### BACKGROUND OF THE INVENTION

3-D printing is an additive manufacturing process that builds a part in a layer-by-layer fashion to create a three-dimensional object from a digital model. Initially developed in the mid 1980's and used subsequently in highly specialized industries with the expertise and financial means to mitigate the high costs, 3-D printing has recently become a technology that is cheap and accessible to almost anyone. Today's 3D printers include room sized systems but are more typically desktop instruments and can be used for creating and/or prototyping items as disparate as human organ replacements and turbine parts.

Although many materials can be used to make 3D printed parts, many materials are difficult or impossible to use as the print feedstock using current 3D printing technology. There therefore is a need for 3D printers and methods of printing unconventional materials.

### SUMMARY

In general, methods equipment and systems are described herein for the production of parts using liquid and/or paste feedstocks. For example, parts are created using 3D printers and low viscosity feed materials such as food based liquids and pastes, thermoset plastic precursors, thermoplastics and metal containing pastes.

In accordance with the invention there is provided a method for producing an object using a 3D printer. The method includes printing a first portion of the object onto a 3D printer surface, the first portion of the object comprising a first food material and the first portion of the object defining at least a portion of at least one container having at least one wall, a floor and an opening. The method also includes depositing a liquid through the opening of the at least one container, for example, the liquid comprising a second food material. Optionally the container defines a liquid fillable volume. In some implementations, the liquid has a volume which is less than about the liquid fillable volume. Optionally at least one portion of the container comprises the 3D printer surface, for example, a portion of the floor and/or walls can be part of the 3D printer surface. Also optionally, at least a portion of the floor of the container comprises the 3D printer surface. Optionally, the container floor comprises the first food material. Optionally, the liquid takes the shape of the container being deposited through the opening, such that the liquid takes the shape of at least a portion of the volume inside the container including covering the inside bottom of the container and at least a portion of the inner wall(s). For example within about 5 minutes of less of being deposited through the opening (e.g., within about 1 min or less or within about 10 seconds or less) the liquid covers the inside bottom of the container and at least a portion of the inside walls. Also optionally the container retains its structure integrity while the liquid takes the shape of the container. For example, the liquid flows into the container and does not leak out of the container. For example, less than 50 vol. % (e.g., less than 20 vol. %, less than 10 vol. %, less than 1 vol. %) of the liquid is absorbed into the first food material or leaks out of the container. In some implementations, the 3D printer surface can be removed from the 3D printer. For example, the 3D printer surface can be a tray that sits on the stage of the 3D printer. The tray can be held in place, for example, by magnetic means and/or quick release clasps. In the method, the tray can optionally be removed and cleaned and/or sterilized. The tray can be made of a food grade material. For example, the tray can be removed by an operator, by means of a conveyor, and/or a robotic means such as a robotic arm. The method also includes removing the tray with the printed part and curing the part, for example in an oven. Optionally, printing the first portion of the object comprises extruding the first food material through a first nozzle, and also optionally depositing a liquid comprises extruding the liquid through a second nozzle. For example, the first and/or second nozzle can be in fluid communication with a syringe equipped with a linear actuator for depressing the plunger into the barrel of the syringe. In some implementations, the first food material and/or the liquid is extruded through the first and/or second nozzle using a screw extruder or a progressive cavity pump. Optionally, the method further comprises heating the first portion of the object prior to depositing the liquid through the opening (e.g., curing the first portion of the object).

In some implementations the method further includes curing the liquid to form an at least partially cured liquid and/or at least partially curing the first food material. Optionally, curing the liquid to form an at least partially cured liquid is initiated prior to depositing the liquid through the opening of the at least one container (e.g., in a nozzle). Optionally the container maintains its structural integrity while the liquid and/or the first food material is cured. Optionally, the first portion of the object does not change its liquid fillable volume by more than about 50% during a curing step (e.g., by not more than 40%, by not more than 30%, by not more than 20%, by not more than 10%). Optionally, the first portion of the object does not change in any dimension during a curing step by more than 50% (e.g., by not more than 40%, by not more than 30%, by not more than 20%, by not more than 10%). Optionally, the first portion of the object does not produce carbon dioxide during a curing step.

Optionally, curing is initiated by energy from an energy source selected from the group consisting of a resistive heater (e.g., an oven and/or a heat gun), an electron gun, a UV lamp, a visible light lamp, an IR lamp, a chemical reaction (e.g., combustion or another exothermic reaction), a laser, and combinations of these. For example wherein the energy source directs energy at the liquid and/or the first food material. Optionally, curing is initiated and also maintained using the aforementioned energy source (e.g., the energy source optionally may need to be applied continuously to complete the curing process). Optionally curing comprises heating the liquid and/or first food material, for example using a heat gun, an oven and or a heat lamp. In some implementations, the object is removed from the 3D printer surface prior to at least partially curing the liquid and/or first food material, while in other implementations the object is at least partially cured while the object is disposed on the 3D printer surface.

In some implementations, the method further includes printing a second portion of the object, the second portion of the object comprising a food material selected from the group consisting of the first food material and a third food material, and the second and first portion of the object defines a total liquid fillable volume amount. This method also can further include depositing an addition portion of liquid through the opening of the container, the additional liquid comprising a food material selected from the group consisting of the second food and a fourth food material, and the liquid and additional liquid providing a sum of liquid volume deposited through the opening of the container. Optionally, the total liquid fillable volume amount is larger than the sum of the volume of the liquid deposited through the opening of the container.

Optionally the liquid has a viscosity between about 1 and 1 million centipoise at 25° C. (e.g., between 1 and about 10,000 centipoise). Optionally the method can further include depositing solid material through the opening of the container (e.g., such as nuts, chocolate chips, ceramic materials). The method can also include homogenizing the solid material and the liquid prior to depositing the liquid and the solid material through the opening of the container. Optionally the first food material has a viscosity greater than about 10,000 centipoise at room temperature.

In some implementations the first portion of the object comprises a particulate material selected from maize, wheat, potato, rice, buckwheat, barley, spelt, rye, soy, oat, peanut, almond, coconut, walnut, chestnut, hazelnut, tapioca, garbanzo bean, black bean, arrowroot, amaranth, teff, sesame seed, sunflower seed, chia seed, flax seed, quinoa, xanthan gum, guar gum, kamut, millet and mixtures of these. In some implementations the first portion of the object comprises at least 1% ethanol.

Optionally the liquid includes a monomer which is a precursor to a thermoset plastic.

Also in accordance with the invention there is provide a method for producing a part using a 3D printer. The method includes printing a first portion of the part, the first portion of the part comprising a thermoplastic, and the first portion of the part defining at least one container having a bottom, walls and an opening. The method also includes depositing a liquid through the opening of at least one of the at least one container, the liquid being capable of being cured. The method further includes at least partially curing the liquid to form an at least partially cured liquid. The method also includes depositing a second portion of liquid on the at least partially cured liquid and at least partially curing the second portion of the liquid to form a second at least partially cured liquid.

Optionally, depositing comprises flowing the liquid through a nozzle above the opening while moving the nozzle relative to the first portion of the part. Also optionally, the container and additional layers of thermoplastic is impermeable to the liquid.

In some implementations of the method for producing a part, curing comprises providing energy to the liquid. For example energy can be selected from the group consisting of thermal energy, ultra-violet (UV) light, visible light, infrared (IR) light, ionizing energy, chemical energy, and combinations of these. In additional implementations the liquid is a two or more part thermoset precursor. For example, wherein one part of the thermoset precursor includes a catalysts and a second part of the thermoset precursor includes an activator. Optionally the method can include mixing the two or more part thermoset precursor prior to depositing the liquid. For example, mixing can be accomplished by flowing the two parts through a mixer such as a static in-line mixer. In some other implementations, the liquid comprises a monomer. For example the monomer can be selected from the group consisting of dicyclopentadiene, norbornadiene, substituted dicyclopentadiene, substituted norbornadiene, cyclooctene, cyclic olefins, and mixtures thereof. The monomer can be dicyclopentadiene. The monomer can be norbornadiene. The monomer can be a substituted dicyclopentadiene. The monomer can be a substituted norbornadiene. The monomer can be cyclooctene. The monomer can be a cyclic olefin. Optionally, the monomer can be a photo polymer precursor. Also optionally, the monomer can be an acrylate. The monomer can optionally be an epoxide. In some further implementations the liquid includes a cross-linking polymer such as a siloxane. In some implementations the cross-linking polymer includes an epoxide. Optionally the method can further include curing the at least partially cured part after it has been printed by removing the part from the printer and placing it in a curing environment. For example, wherein the 3D printer includes a removable stage upon which the part is made and this is removed with the part for additional curing of the part.

Optionally, the method for producing a part includes filling less than all the containers or all of the container volumes that are made or available so that the final part has a void volume between about 1% and about 99% (e.g., between about 5% and about 95%). In some implementations the liquid comprises a solid material dispersed therein (e.g., fibers and/or particulates of glass, carbon, wood, ceramic, cellulose or plastic). For example a part that is made can include solid materials such as glass fibers, carbon fibers, wood fibers, ceramic fibers and plastic fibers. Optionally, the first portion of the part includes another thermoplastic. For example, combinations of acrylonitrile butadiene styrene (ABS) and a nylon. In some implementations, the steps described above (e.g., printing a first portion, depositing a liquid in a container of the first part, curing the liquid, depositing a second portion, depositing additional liquid and curing the additional liquid) are repeated, for example so as to increase the overall size of the part. The method can therefore include printing an additional portion of the part, the additional portion of the part comprising a thermoplastic, and the additional portion of the part increasing the volume of the at least one container; depositing an additional portion of liquid on the second at least partially cured liquid; and at least partially curing the additional portion of liquid to form an additional at least partially cured liquid.

Also in accordance with the invention there is provided a 3D printer for producing a part (e.g., or object). The printer includes at least one thermoplastic extruder (e.g., a thermoplastic and/or food extruder), at least one liquid extruder (e.g., a thermoset monomer and/or liquid food extruder), a stage for receiving extruded material from the extruder(s), and a computer control system for executing an algorithm. The algorithm is for: printing a first portion of the part, the first portion of the part (e.g., a thermoplastic or a food) defining at least one container having a floor, walls and an open top; depositing a liquid through the open top of at least one of the at least one container, said liquid being capable of being cured; at least partially curing the liquid to form an at least partially cured liquid; printing a second portion of the part, the second portion of the part comprising a thermoplastic, and the second portion of the part increasing the volume of the at least one container; depositing a second portion of liquid on the at least partially cured liquid; and at least partially curing the second portion of the liquid to form a second at least partially cured liquid. The algorithm can further include the steps of: printing an additional portion of the part, for example the additional portion of the part comprising a thermoplastic or a food, and the additional portion of the part increasing the volume of the at least one container; depositing an additional portion of liquid on the second at least partially cured liquid; at least partially curing the additional portion of liquid to form an additional at least partially cured liquid.

In some implementations, the printer further includes an energy source disposed to direct energy at the material extruded from the at least one liquid extruder. For example, the energy source is selected from the group consisting of a resistive heater, an electron gun, a UV lamp, a visible light lamp, an IR lamp, a chemical, and combinations thereof.

Optionally the liquid extruder includes at least two chambers for containing liquid, and the 3D printer further comprises a mixer (e.g., an in-line or static mixer) in fluid communication with the two chambers.

In some implementations the printer further includes a heated and insulated enclosure disposed to enclose the stage and extruded materials on the stage, a heater disposed to heat the insulated enclosure wherein the insulated enclosure and heater can maintain a temperature above 35 degrees Celsius therein. Optionally the insulated enclosure and heater can maintain a temperature above about 100 degrees Celsius therein.

In some implementations the printer includes a pressure break seal or pressure release disposed on any one of the extruders or equipment in fluid communication with an extruder.

In accordance with the invention there is also provide a 3D printed part comprising a thermoplastic or food shell surrounding a core, wherein the core is selected from the group consisting of a thermoset polymer, a composite comprising a thermoset polymer and a food material. Optionally, the thermoset polymer is made from the monomers selected from the group consisting of dicyclopentadiene, norbornadiene, substituted dicyclopentadiene, substituted norbornadiene, cyclooctene, cyclic olefins, and mixtures thereof. Optionally, the thermoset polymer is a polysiloxane. Optionally the thermoset is an epoxy resin. In some implementations the part includes an organometallic. Optionally the part includes a void volume between about 1% and about 99% (e.g., between about 5% and 95%). Optionally, the thermoplastic comprises more than one type of thermoplastic.

In another aspect, the invention provides for a 3D printer for producing a part using a paste. The printer includes a chamber capable of containing the paste wherein the chamber includes at least one movable wall. There is also included a mechanism for moving the wall which is CNC controlled. The chamber furthermore includes an opening through which the paste can be extruded. The printer includes a stage, such as a flat surface or plate (e.g., a 3D printer surface). Optionally the stage or a portion of the stage is removable (e.g., designed with quick release fasteners to allow part or the whole stage to be removed). The stage is disposed for receiving the extruded material from the opening in the chamber and the relative position of the stage and opening is CNC controlled. In some implementations, the mechanism for moving the wall is a linear actuator in mechanical communication with the wall. Optionally the movable wall is configured as an extruder screw drive or continuous cavity pump. Optionally, the printer comprises more than one of the chambers (e.g., two or more). Optionally, the 3D printer further includes a nozzle through which the paste can be extruded, the nozzle being attached to the chamber opening. Optionally, the 3D printer further includes a nozzle through which the paste can be extruded and a static mixer in fluid communication with at least two chambers and the nozzle. Optionally the nozzle is disposable. Optionally or additionally the static mixer is disposable. Additionally or alternatively, the 3D printer further includes an energy source directing energy at the extruded material (e.g., an energy source fixed to the chamber). For example, the extruded material can be disposed between the energy source and the stage. One example includes an energy source that provides heat. The energy source can be selected from the group consisting of a hot air gun, an infra-red (IR) lamp, a resistive heater, and combinations of these. In some implementations, the 3D printer further includes a thermal insulation disposed to surround the extruded material deposited on the stage. For example, in some implementations, the energy source is capable of heating the extruded material to a temperature of at least about 35 degrees Celsius (e.g., at least about 40 degree Celsius, at least 50 degree Celsius, at least 60 degree Celsius, at least 70 degree Celsius, at least 80 degree Celsius, at least 90 degree Celsius, at least 100 degree Celsius, at least degree Celsius, at least 120 degree Celsius). In some implementations the thermal insulation is capable of maintaining the temperature of extruded material on the stage at a temperature of at least about 35 degrees Celsius (e.g., at least about 40 degree Celsius, at least about 50 degree Celsius, at least about 60 degree Celsius, at least about 70 degree Celsius, at least about 80 degree Celsius, at least about 90 degree Celsius, at least about 100 degree Celsius, at least about 120 degree Celsius). In some implementations, the 3D printer further includes an extruder for deposition of a second material on the stage. For example, the second extruder can be a clay extruder, a fused deposition modeling type extruder, a paste extruder, a liquid extruder or an applicator. The second extruder can include an energy source directing energy at the extruded second material. In some further implementations, the chamber opening of the 3D printer includes a nozzle through which the paste can be extruded and the nozzle is stationary relative to the chamber when the 3D printer is producing the part. In some implementation, the chamber, wall, linear actuator, and opening are capable of extruding a feed material having a viscosity greater than 1 million centipoise through said opening (e.g., greater than 2 million centipoise, greater than 10 million centipoise). Optionally, the chamber walls are metal (e.g., stainless steel or Hastelloy). Also optionally, the chamber is rated to withstand an internal pressure of at least 2000 psig. In some implementations, the chamber is in the form of a syringe. In other implementations the chamber is in the form of a screw extruder or continuous cavity pump. In some other implementations, the 3D printer, further includes a tube and a nozzle, wherein the tube is disposed between the chamber and nozzle and wherein the chamber, nozzle and tube are in fluid communication with each other and wherein the paste extrudes from the chamber, through the tube and through the nozzle to be deposited on the stage. Optionally, the tube is a flexible high pressure tube. Also optionally, the tube comprises metal. Optionally, the tube and chamber are connected e.g., in fluid communication with an in-line mixer. Optionally, the in-line mixer is disposable. Optionally the nozzle is disposable. In some implementations, the chamber includes a cooling loop (e.g., a cooling jacket such as supplied by a cooled glycol solution). In some implementations, the tube includes a cooling loop. In some implementations, the chamber opening includes a stopcock for controlling (e.g., stopping flow out of the chamber) or a one way valve (e.g., for allowing flow only out of the chamber). For example, the contents of the interior of the chamber can be isolated from material (e.g., air) outside of the chamber. In some implementations, the 3D printer includes a pressure release valve or pressure break seal disposed on the chamber. In some implementations, the 3D printer includes a pressure release valve or pressure break seal disposed on the static mixer.

In a further aspect, the invention provides a method of producing a 3D part using a paste (e.g., as the feed material, a first deposited material). The method includes extruding an uncured feed material through a nozzle and onto a stage in a layer-by-layer fashion. The method also includes at least partially curing the deposited uncured material while extruding the uncured feed material. The method produces a deposited part that is an at least partially cured material. Optionally the uncured feed material has a viscosity of at least greater than about 1 million centipoise (e.g., greater than 2 million centipoise, greater than 10 million centipoise) while being extruded through the nozzle. Optionally, the uncured feed material is fed through the nozzle using a syringe equipped with a linear actuator. In some implementations, the uncured feed material is fed through the nozzle using a screw extruder or a progressive cavity pump. In some implementations the method includes depositing a support material (e.g., a second material) on the stage in a layer by layer fashion. Optionally the support material is an uncured ceramic material. Optionally the support material is at least partially cured after being extruded. Also optionally, the cured or partially cured support material is more brittle than the other, non-support material. In an alternative description, the first cured or partially cured deposited material has a higher toughness than the second cured or partially cured support material. For example the first cured or partially cured material can have a toughness that is greater than about 0.1 KJ/m² (e.g., greater than about 1 KJ/m²) and the second cured or partially cured material can have a toughness that is less than about 0.1 KJ/m² (e.g., less than about 0.01 KJ/m²). Optionally, the first cured or partially cured deposited material is more resilient than the second cured or partially cured support material. Optionally the support material is dissolvable (e.g., can be washed away with water, wherein the water disrupts the structure even if it does not dissolve all the components, or can be dissolved such as ABS dissolves in acetone). Optionally the support material can be melted and removed from the first deposited material. Optionally the uncured material (e.g., the first deposited material) is deposited at least in part on the support material. In some implementations of the method curing is done by directing energy at the deposited uncured material. Optionally, the energy is directed at the deposited uncured material from a direction that places the material between the energy source and the stage. Optionally, the energy is heat, for example wherein the heat is provided by an energy producing device selected from the group consisting of a hot air gun, an IR lamp and a resistive heater. Optionally, the energy is UV or visible light, for example provided as a laser light. In some implementations the method further includes heating the deposited uncured material (e.g., the first material) to at least about 35 degree Celsius (e.g., at least about 40 degree Celsius, at least about 50 degree Celsius, at least about 60 degree Celsius, at least about 70 degree Celsius, at least about 80 degree Celsius, at least about 90 degree Celsius, at least about 100 degree Celsius, at least about 120 degree Celsius). Optionally, the method further includes maintaining the deposited uncured material at a temperature of at least about 35 degrees Celsius while it is being cured (e.g., at least about 40 degree Celsius, at least 50 degree Celsius, at least 60 degree Celsius, at least 70 degree Celsius, at least 80 degree Celsius, at least 90 degree Celsius, at least 100 degree Celsius, at least degree Celsius, at least 120 degree Celsius). In some implementations of the methods, the uncured feed material comprises a silicone. For example, a one part silicone, or a two part silicone. Optionally the silicone can be a high temperature curing silicone. In some implementations, the uncured feed material is an edible material (e.g., a cake, brownie or cookie dough).

Also in accordance with the invention, there is provided a method for producing an object by mixing a powder and a binder thereby providing a feedstock, heating the feedstock, and extruding the feedstock through a nozzle and onto a stage in a layer-by-layer fashion while allowing the extruded feedstock to cool producing a green part. Optionally the feedstock is heated to at least the melting point of the binder and below the melting point of the powder. Optionally the extruded feedstock is cooled to below the melting point of the binder. In some implementations, the binder has a melting point of less than about 300° C. (e.g., less than about 250° C., preferably less than about 200° C.) and above about 100° C. (e.g., preferably above about 120° C.). Optionally the binder includes a thermoplastic and a surface active agent. In some implementations the thermoplastic comprises a mixture of a low molecular weight polymer and a higher molecular weight polymer. For example, the low molecular weight polymer has a number average molecular weight below about 1,000 g/mol and the higher molecular weight polymer has an average molecular weight above about 1,000 g/mol. Optionally the surface active agent includes organic compounds with one or more functional groups selected from the group consisting of carboxylate, amine, ketone, ester, amide and salts thereof. In some implementations the powder is selected from the group consisting of a metal, a ceramic or mixtures of these. Optionally the powder is a metal selected from the group consisting of iron, nickel, chromium, zinc, cobalt, titanium, cadmium, molybdenum, tungsten, copper, gold, lead, aluminum, magnesium, manganese, silver, tin, platinum, palladium, iridium, rhodium, ruthenium, alloys of these and mixtures of these. In some implementations the metal power further includes an element selected from the group consisting of oxygen, carbon, silica, arsenic, sulfur, nitrogen, antimony and phosphorous (e.g., carbon steel). In some implementations the method further includes removing at least a portion of the binder producing a brown part. In some implementations the method further includes removing at least a portion of the green part prior to removing the binder (e.g., removing a raft or support material at the green part stage). In some other implementations the method further includes heating at least a portion of the brown part producing a sintered part. Other implementations can further include removing at least a portion of the brown part prior to sintering the brown part (e.g., removing a raft or support material at the brown part stage). In some implementations mixing the powder and binder includes fusing the powder and binder and forming it into a 3D solid which is the feedstock. Optionally, mixing the powder and binder comprises fusing the powder and binder and forming it into a 3D solid which is the feedstock. Optionally, fusing and forming include injection molding the powder and binder into the 3D solid feedstock, e.g., wherein the 3D solid is in the form of a cylinder.

Also in accordance with the invention, there is provided a 3D printer for producing a metal containing object. The 3D printer includes a chamber for containing a feedstock, the chamber including at least one movable wall; a mechanism for moving the wall, the mechanism being CNC controlled; an opening in the chamber through which the feedstock can be extruded to produce extruded material; and a stage for receiving the extruded material from the opening, wherein the relative position of the stage and the opening is CNC controlled. In some implementations the 3D printer includes a vibratory actuator coupled to the chamber. Optionally the 3D printer includes a gas release opening disposed in the chamber controlled by a stopcock or valve and configured to release gas from the chamber prior to extruding the feedstock through the opening. Optionally the mechanism for moving the wall is a linear actuator in mechanical communication with the wall. Optionally the movable wall is configured as an extruder screw drive. Optionally the 3D printer comprises more than one of said chambers. In some implementations the printer further includes an energy source for providing heat to at least a portion of the chamber. Optionally the energy source is selected from the group consisting of a hot air gun, an IR lamp, a resistive heater, and combinations of these. Optionally the energy source is a resistive heater. Optionally the energy source is capable of heating at least a portion of the chamber to at least 120° C. In some implementations the 3D printer includes an extruder for deposition of a second material onto the stage. Optionally the opening includes a nozzle through which the material can be extruded and the nozzle is stationary relative to the chamber when the 3D printer is producing the part. In some implementations the 3D printer includes a heater to heat the nozzle to at least 120° C. Optionally at least a portion of the chamber walls are metal (e.g., stainless steel or Hastelloy). Optionally the chamber is in the form of a syringe or screw extruder. In some implementations the 3D printer further includes a tube and a nozzle, wherein the tube is disposed between the chamber and nozzle and wherein the chamber, nozzle and tube are in fluid communication with each other and wherein the material extrudes from the chamber, through the tube and through the nozzle to be deposited on the stage. Optionally the tube is a flexible high pressure tube. Optionally the tube comprises metal. In some implementation the 3D printer includes a nozzle through which the material can be extruded, the nozzle is in fluid communication with the chamber and the nozzle is disposable. Optionally the chamber opening includes a stopcock or one way valve for controlling the flow of material into and/or out of the chamber. Optionally the 3D printer includes a pressure release valve or pressure break seal disposed on the chamber. In some implementations the 3D printer includes an injection molder coupled to the chamber and configured to produce the feedstock as an object commensurate with the dimensions of the chamber.

3D printing using low viscosity materials or using high viscosity materials can be difficult. 3D Printing of parts using low viscosity liquids is generally restricted to stereolithographic methods. This limitation is due to the fact that liquids flow and do not maintain structural integrity either under gravity or under mechanical movements/vibrations that may occur during other 3D deposition methods. Not only does this limitation affect the types of materials that can be used for 3D printing, it also makes integration/consolidation of different methods of manufacture difficult. Curing or partially curing during the forming/printing process helps mitigates these issues and is an advantage of the herein described apparatus, systems and methods. Curing or partially curing is also advantages because it speeds up the overall part production and streamlines part making. In addition, printing a container to contain a liquid material and then curing the liquid also provides a method to print using low viscosity materials. Conversely, High viscosity pastes such as those including metal containing particles and high viscosity silicones can be difficult to use as feedstocks in 3D printing. The methods and equipment described herein can be useful for producing parts using these paste materials. In the case of metal containing pastes, further treatment of printed parts such as sintering can produce metal parts.

Other features and advantages of the invention will be apparent from the following drawings, detailed description, and from the claims.

### DESCRIPTION OF THE DRAWINGS

The foregoing will be apparent from the following more particular description of example embodiments of the invention, as illustrated in the accompanying drawings. The drawings are not necessarily to scale, emphasis instead being placed upon illustrating embodiments of the present invention.

FIG. 1 is a pictorial flow diagram showing a method for printing a part.

FIG. 2 is projection view of a part including partially cured liquid and a thermoplastic.

FIG. 3 is a diagrammatic front cross cut view of a 3D printer with two extruders.

FIG. 4 is a diagrammatic front cross cut view of a 3D printer with a filament and mixed liquid or paste extruder.

FIG. 5 is a diagrammatic front cross cut view of a 3D printer with a filament and a liquid extruder including a curing device.

FIG. 6 is a diagrammatic front cross cut view of a 3D printer including an insulating enclosure and heaters.

FIG. 7 is a diagrammatic front cross cut view of a 3D printer including a screw extruder.

FIG. 8 is a diagrammatic front cross cut view of a 3D printer including an insulating flexible shroud.

FIG. 9 is a diagrammatic front cross cut view of a 3D printer including a tube for conveying material to the 3D printer stage.

FIG. 10A is a diagrammatic front cross cut view of a chamber for extruding material.

FIG. 10B is a diagrammatic front cross cut view of another chamber for extruding material.

FIG. 11 is a flow diagram for a method to make a part.

FIGS. 12A, 12B, 12C and 12D is a pictorial flow diagram showing cross cut views of chambers for extruding materials and how to remove air therein before extrusion.

FIG. 13 is a pictorial flow diagram demonstrating a method for producing an initially formed part that can be loaded into an extruder.

FIG. 14A is an isometric projection of a part including a container

FIG. 14B is a front cross cut view of the part including a container.

FIG. 15 is a picture of a thermoplastic/thermoset composite part.

FIG. 16 is a picture of a 3D printed and filled part.

FIG. 17 shows some containers that can be printed and filled.

FIG. 18A shows a part and a 3D printable silicone mask for the part.

FIG. 18B shows a diagrammatic view of the part being protected using the mask during a shot peening process.

### DETAILED DESCRIPTION

Glossary

As used herein, a liquid fillable volume is the volume that a non-permeating ideal liquid can fill a container, not including any liquid that spills out of any opening in the container, while the container is in a quiescent stage (e.g., not under agitation) and it is not under a compression force (e.g., it experiences only about 1 g of gravity). An ideal non-permeable liquid does not permeate through the container material (e.g., does not absorb into its walls) and does not have surface curvature due to adhesion between the molecules of the liquid and the container or cohesion forces between the molecules of the liquid. For example the liquid fillable volume of a water glass would be the maximum amount of water that could be contained in the glass if it were set on a level surface and not including any decrease or increase of water volume due to surface tension causing surface curvature (e.g., not including variation due to a meniscus).

As used herein; x, y and z are Cartesian coordinate points. X, Y and Z refer to the Cartesian directions. Clearly, other coordinate systems can be used by applying the appropriate transfer function, e.g., to polar coordinates.

As used herein, CNC control refers to computer numerical control. For example where the motions of a machine are controlled by a prepared program containing coded alphanumeric data such as G-code. CNC control can control the motion of a print head (e.g., nozzle or an extruder) and stage of a 3D printer relative to each other (e.g., their relative x, y and z position), other energy outputs (e.g., heating, cooling, and electrical power to a laser) and speed of extrusion of a feedstock.

As used herein, viscosity is a measure of a liquid's resistance to deformation by shear or tensile stress. Low viscosity liquids have a viscosity of less than about 10,000 centipoise and can be poured (e.g., up to about the consistency of honey at room temperature). Medium viscosity liquids have a viscosity between about 10,000 centipoise and about 1,000,000 centipoise (e.g., pastes including ketchup and peanut butter) and can be extruded with moderate force but cannot be easily poured. High viscosity liquids have viscosity above about 1,000,000 centipoise and are pastes or putties that cannot be poured (e.g., Caulking compounds, window putty) and require high forces to be extruded.

As used herein, the toughness of a material is defined as the amount of energy per unit volume that a material can absorb before rupturing. The toughness can be determined by integration of a stress-strain curve and it is the energy of mechanical deformation per unit volume prior to fracture.

As used herein, the resilience of a material is the ability of the material to absorb energy when it is deformed elastically and release that energy upon unloading. The modulus of resilience is the energy absorbed per unit volume up to the yield point. It can be calculated by integrating the stress-strain curve from zero to the yield point (e.g., elastic limit). Under uniaxial tension the resilience can be calculated/expressed as the product of the square of the yield stress divided by two times the Young's modulus of elasticity. Some resilience test protocols include ASTM D2632 (Rubber Property, Resilience by Vertical Rebound), ASTM D7121 (Rubber Property, Resilience Using Schob Type Rebound Pendulum), and DIN 53512 (Determination of the rebound resilience of rubber).

As used herein, Young's Modulus is the slope of a stress strain curve for a material in the elastic (e.g., linear) region. Young's Modulus is the ratio of compressive stress to the longitudinal strain and is an indication of a materials stiffness. Stiff materials have a higher Young's Modulus than a flexible material.

As used herein, curing is the process of forming at least one chemical bond between materials such as molecules, solids, particulates, metal-oxide/hydroxide clusters, proteins and/or polymers in a material. For example, a cross linking reaction between polymers is a curing process. As another example, the polymerization of a monomer is also a curing process. Condensation reactions between aluminosilicates can also be considered curing. Yet another example is the processes that can occur during cooking/baking such as mallard reactions, caramelization and/or protein entanglement. A partially cured material has a subset of the possible bonds that can formed by fully curing reacted to form a bond, e.g., less than 80% of the possible bonds that could be formed under fully curing conditions. A fully or substantially cured material has more than about 80% of the possible bonds formed, e.g., the possible bonds are all the bonds that could be formed under the curing conditions. Curing of a materials described herein can increase its viscosity. It is understood that over-curing can decrease viscosity since bonds can also be broken under curing conditions.

As used herein, a food or food material means a raw, cooked, or processed edible substance, ice, beverage, or ingredient used or intended for use or for sale in whole or in part for human consumption, or chewing gum. A food ingredient can be one or more ingredients that make a food or food material.

As used herein, the term “porosity” means the relative proportion of the volume of voids. For example, a material having a porosity of 20% means that 20% of the material volume comprises voids (e.g. spaces, holes, gaps etc.).

As used herein, a linear actuator refers to an actuator that creates motion in a straight linear path.

As used herein Cermets are composite materials of ceramic and metals. The matrix can be a ceramic material, such as when there is more ceramic by volume than metal and the metal forms particles embedded in the ceramic. Alternatively, the metal can form the matrix with ceramic particles embedded therein.

### EMBODIMENTS

Using the equipment, methods and systems described herein, a curable liquid can be used for making parts. The liquid material can be cured or partially cured during 3D printing of the part. For example, 3D printers and methods are described that can be used for printing using liquids of low, medium and high viscosities. For example, 3D printers are described that can be used for printing using two part epoxies, food pastes, high viscosity silicones and pastes including metal particles.

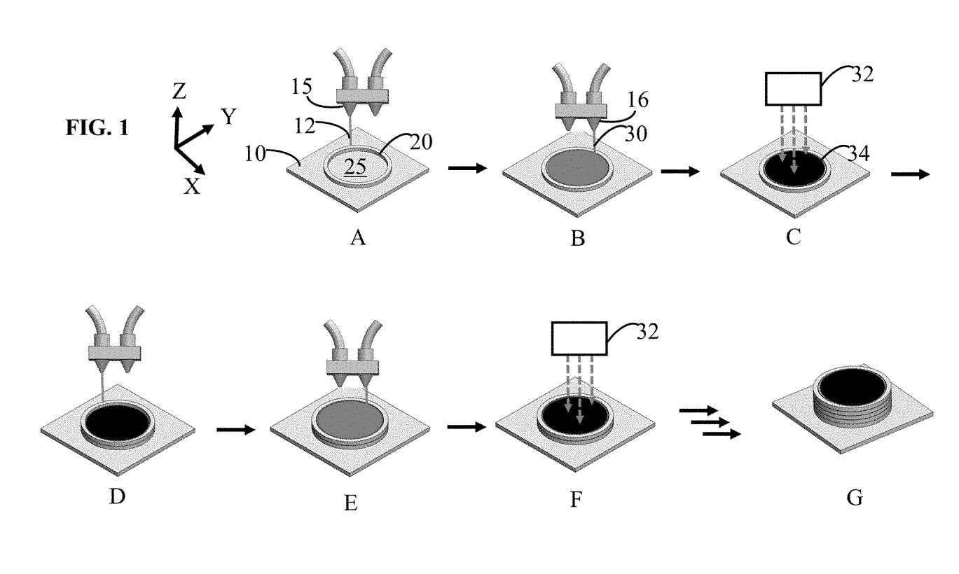

FIG. 1 is a pictorial flow diagram showing an embodiment of a method for printing a part. The method includes: step A, print a container; step B, infill the container; step C, cure the infill; step D, increase the container size; step E, add additional infill; step F, cure the additional infill; and step G, repeat steps D-F until desired part is made. Details for these steps are outlined below.

Step A is to print a container. The container is a portion of the final part to be printed. The container is printed on a surface, such as a stage 10 of a 3D printer (e.g., a 3D printer surface). The container is printed by extruding a liquid or paste material 12 such as a molten material, (e.g., examples of 12 can be a thermoplastic or a food paste) through a first opening such as first nozzle 15. The material is deposited onto the platform and/or previously deposited material to build the part. For example if the material is a thermoplastic, it can fuse onto the platform or previously deposited thermoplastic. The portion of the part, in FIG. 1 is configured as circular container with a circular wall 20 and an open top. The bottom of the container 25 is the platform (alternatively it can be a surface made from the extruded material). Preferably, the top of the walls (e.g., the top of the walls are the position closest to the extruding nozzle 15) are coincident with a plane that is parallel to the surface 10. It is contemplated that for other embodiments the container can have walls in any configuration and/or shape and that the part may be made with more than one container. The container can be any height (e.g., in the Z direction, Z shown in FIG. 1), for example between about 10 microns and about 100 cm (e.g., between about 10 microns and about 10 cm, between about 100 microns and about 1 cm, between about 100 microns and about 1 mm). The dimensions of the container are at least in part determined by the sized of the 3D printer. The container defines a liquid fillable volume which is this embodiment is the equal to the inner volume (LFV) of the cylinder:

LFV=h·πr²: where h is the height and r is the inner radius.

Step B is an infilling step. In this step liquid 30 is deposited in the container through the open top. Deposition can be done by using a second nozzle 16 although single nozzle configurations are also possible (e.g., where both 20 and 30 are deposited from the same nozzle, or 30 is poured in manually). Preferably the amount of liquid used is less than or equal to the volume of the container (e.g., the liquid fillable volume) so that the liquid does not overflow out of the container. The direction Z is indicated as perpendicular to the stage 10 and is opposite to the direction of gravity (or an artificial gravity such as could be generated on a space ship or space station). In some other embodiments, filling can be done by dipping the entire container into a dipping tank of the liquid and then bringing it out of the tank.

Step C is a curing step. After infilling, the liquid is cured or at least partially cured. For example the material can be cured using an energy depicted as the dotted arrows in FIG. 1, produced by device 32 and impinging on the curing liquid 34. In some embodiments the device is not needed as the liquid may be self-curing and/or cures due to exposure to ambient conditions of light, moisture or air.

Step D prints a second portion of the part and increases the container volume by adding material to the container walls. Additional material, such as the thermoplastic, is deposited on the surface of the previously deposited thermoplastic at an incrementally higher Z position (e.g., where higher denotes a direction away from the stage) and in a plane parallel to X and Y. Alternatively or additionally, the thermoplastic can be deposited on the at least partially cured liquid. For example, the wall can be angled inwards towards the center of the container making a smaller diameter wall so that at least some of the thermoplastic is deposited on the partially cured material. The wall diameter can also be increased so that the wall angles outwards from the center of the container. In all cases deposition increases the height of the part in the Z direction. The amount of increase can be any height, for example between about 10 microns and about 100 cm (e.g., between about 10 microns and 10 cm, between about 100 microns and about 1 cm, between about 100 microns and about 1 mm). The increase in height can be the same as the initial height of the portion of the part printed in step A or a different height. The additional material can be the same material as used in step A, or it can be a different material.

In step E, a second portion of liquid is deposited on the at least partially cured liquid. The liquid is preferably added to just below the top of the newly deposited wall so that it does not overflow. Alternatively, as in step B the step can include dipping the entire container into a dipping tank of liquid and then bringing it out of the dipping tank thus filling the container above the already at least partially cured liquid. The second portion of liquid can be the same liquid as used in step B or a different liquid.

The second portion of liquid is at least partially cured in step F.

Step G includes repeating the steps of increasing the container size (e.g., with the same or new materials), adding additional infill (e.g., with new or the same liquids) and curing the infill. This can be done many times to build up an entire part. A final step can include closing the container opening by printing a material covering the opening or curing a portion of the curable liquid.

In some embodiments the steps described with reference to FIG. 1 can all be done using a single 3D printer. In other embodiments a 3D printing system can include several 3D printers in series where the stage 10 is moved (e.g., placed and/or conveyed) after one or more steps. Such a system can be effective for continuous production of parts and rapid overall production. In this embodiment, each step can be at a different location and/or different stations specialized for a specific activity (e.g., printing, filling or curing). In such systems bottle neck steps can be optimized (e.g., the time for these steps can be minimized), for example if one of the steps is slow, duplicates of equipment at that step can be used, e.g., if curing is slow then several or a single device 32 can be utilized to irradiate several parts at a time. One example of such a system would be to use the following steps: step A is done in a first location, a mechanical arm moves the stage to a second location for step B and C, the mechanical arm then moves the stage back to the first location for step D, then back to the second location for step E and F and then repeating these movements for step G.

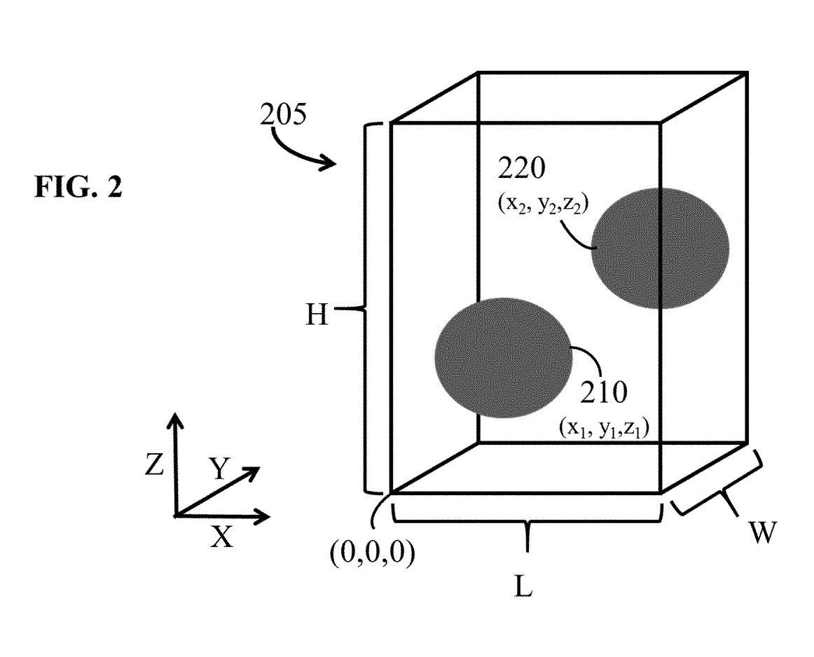

In some embodiments more than one container is produced in a single part. The containers can be started at any layer in the layer-by-layer deposition of the part. For example, FIG. 2 shows a part 205 oriented with a front left corner at position (0,0,0) and with two spherically shaped at least partially cured materials therein; 210 with center at position (x₁, y₁, z₁) and 220 with center at position (x₂, y₂, z₂). The part has dimensions of length L, width W and height H where: 0<x₁ and x₂<L; 0<y₁ and y₂<W; and 0<z₁ and z₂<H. For example, possible coordinates can be x₁=0.3 L, y₁=0.5 W and z₁=0.3H and x₂=0.6 L, y₂=0.5 W, z₂=0.6H, where the coordinates refer to the center of the depicted spheres. Printing of this part can be in any direction. For example, layers in the X Y plane can be printed while incrementing (e.g., segmented or step like movement) upwards in the Z direction. In particular, the direction for incrementing or segmented movement (e.g., Z in the above) is preferably in the direction opposite the force of gravity or artificial gravity.

In some embodiments the nozzle 16 (FIG. 1) is stationary relative to the container while the container is being filled. For example, with low viscosity liquids where the liquid quickly flows and covers the bottom of the container (e.g., within about 5 minutes of less, within about 1 min or less or within about 10 seconds or less the liquid covers the bottom of the container and at least a portion of the walls) and the surface of the liquid opposite the bottom forms a level surface. In other embodiments the nozzle moves while filling the container. For example the nozzle moves in an X Y plane in a raster or spiral fashion while extruding liquid. Moving the nozzle can be useful for medium viscosity liquids that might flow slowly and would not cover the bottom and form a level surface in a reasonable amount of time (e.g., about 5 minutes of less, within about 1 min or less or within about 10 seconds or less) if deposited in only one location. Other embodiments include movement of the liquid rather than or in addition to movement of the nozzle to help cover the bottom of the container and form a level surface. For example, the stage can be vibrated, or sonication can be utilized. Covering the bottom surface and leveling might be also be accomplished by a mechanical means such as a leveling bar, squeegee or a brush.

In some optional embodiments the deposition of the liquid in the container can be by spraying the liquid. For example, the liquid can be aerosolized.

The methods also include producing parts that have void volumes between about 5% and 90%. For example, voids can be created in a thermoplastic material so that less thermoplastic is utilized and the part is printed more quickly. For example, the void volume can be increased by filling less than all of the chambers if more than one chamber is produced in the part.

The first portion of the part can include a thermoplastic. For example the thermoplastic can be selected from the group consisting of at least one of acrylonitrile butadiene styrene (ABS), polylactic acid, polyamide, polyethylene terephthalate, polyurethane, polycarbonate, fluoropolymers (e.g., polytetrafluoroethylene and polyfluoro vinylidene), polyvinyl chloride, polystyrene, polypropylene, polyphenylene sulfide, polyphenylene oxide, polyethylene, polyetherimide, polyetherether ketone, polybenzimidazole, poly(methyl methacrylate), polyamide imide, polysulfone, polyether sulfone, polythalamide, polybutylene terephthalate, polypropylene terephthalate, polyacetal, polyphthalamide, polyphenylene sulfide, polyvinylidene fluoride, styrene acrylonitrile, styrene maleic anhydride, acylate styrene acrylonitrile, polyesters, cellulose acetate, cellulose acetate butyrate, cellulose acetate propionate, cellulose nitrate, ethylene vinyl alcohol, ethylene vinyl acetate, ionomer, polyacrylonitrile, and copolymers of these. Some preferred embodiments include combinations of thermoplastics with complimentary physical properties, for example one might have a high resilience while another have a toughness e.g., a Nylon combined with polycarbonate. One may have a high density and the other a low density e.g., polyacetal and polyethylene. One may be biodegradable while the other is not e.g., Polylactic acid and ABS. The thermoplastic can also be a food material such as chocolate, caramel, fondant and icing.

In some embodiments the thermoplastic is selected to be easy to remove from the at least partially cured liquid. For example the thermoplastic material is soluble in acid, base or an organic solvent. In another alternative the thermoplastic is brittle and can be shattered easily. For example, the thermoplastic can be less resilient than the at least partially cured liquid.

In preferred embodiments the container is substantially impermeable to the liquid. For example, the liquid is substantially impermeable for at least the time it take to partially cure the liquid in curing steps. For example, less than 80 vol. % of the liquid passes through or into the walls of the container (e.g., less than 90 vol. %). In some embodiments the liquid may change the permeability of the walls, for example decreasing it by swelling or otherwise reacting with the wall material and making the walls more impermeable. In some embodiments a sealant is applied to the walls of the container. For example, a spray containing plastic particulates and/or dissolved plastic (e.g., plastics such as a thermoplastic) and a volatile solvent such as acetone, toluene, propane, butane, ethyl 3-ethoxypropionate and/or aromatic hydrocarbons.

In some embodiments the first portion of the part can include a paste or similar material that is extruded through a paste extruder such as a syringe, a peristaltic pump, a progressive cavity pump or screw extruder. For example the material can be a paste made of particulates and a liquid. Particulate materials can be selected from maize, wheat, potato, rice, buckwheat, barley, spelt, rye, soy, oat, peanut, almond, coconut, walnut, chestnut, hazelnut, tapioca, garbanzo bean, black bean, arrowroot, amaranth, teff, sesame seed, sunflower seed, chia seed, flax seed, quinoa, xanthan gum, guar gum, kamut, millet and mixtures of these. The particulate materials preferably have a small size such that they can form a suspension or emulsion that is stable, for example having an average particle size less than about 1 mm in diameter. In addition, the particles are preferably be smaller than any nozzle through which they are extruded. Some pastes can be made of a food material such as starches, water and a viscosity modifying agent such as xanthan gum. Other pastes include sugar pastes (e.g., also known as gum paste or sugar gum), fondant, marzipan or icing. In some embodiments a volatile liquid can be added to the paste, such as ethanol between about 1 and 50 vol % (e.g., between 5 and about 30 vol. %). In some preferred embodiments the paste can be cured once extruded e.g., by heat. In some embodiments the paste is bakeable such that it does not burn (e.g., does not char or become non-edible material) or melt. In embodiments where the paste is bakeable preferably it can be heated to up to about 400 degrees Fahrenheit for more than about 15 minutes (e.g., more than about 30 min, more than about 45 min) without melting or charring. Preferably the bakeable material does not change in volume during baking by more than about 50% and more preferably it does not change in any volume during baking by more than about 20%. For example, the bakeable paste can be a paste that does form a porous material during baking, e.g., it does not contain any ingredients that form carbon dioxide under the curing/baking conditions or prior to curing/baking (e.g., the paste does not contain carbonates or yeasts). In addition, preferably the paste does not become distorted during the heat treatment. For example, the change in any dimension does not exceed 50% and more preferably not exceeding 20%. That is, if a part has a wall thickness is 0.5 cm and 2 cm tall, the part preferably has a wall thickness between 0.25 cm and 0.75 cm and preferably a wall height between 1 cm and 3 cm after heating. More preferably, after heating the wall thickness will be between about 0.4 cm and 0.6 cm, and the wall height will be between 1.6 cm and 2.4 cm. Most preferably, the change in any dimension does not exceed about 10%. The heat resistant paste can also be icing, for example, a heat resistant icing such as described in U.S. Pat. No. 6,368,645 can be useful for making the first portion of the part. U.S. Pat. No. 6,368,645 is herein incorporated by reference. In some embodiments the paste can also include added minerals and vitamins such as iron and vitamin C. The liquid can also include pharmaceuticals.

Curing of the material (e.g., steps C and F) includes providing energy to the liquid. For example the energy, such as can be provided from device 32 can be thermal energy. For example device 32 can be a heat gun, a resistive heater or a flame. The energy can also be a UV light, visible light, or IR light. For example 32 can be an IR heat lamp, UV lamp, a visible light lamp, or a visible, IR or UV laser. The energy can also include chemical energy. For example, a chemical energy that is due to an exothermic reaction from cross linking reactions in the liquid and/or ring strain release. Preferably, during the curing process, the first portion of the part maintains its structural integrity.

In some embodiments, the liquid comes in two or more parts. For these embodiments, the methods can include mixing the two or more parts prior to filling the container. Preferably mixing is done by using an in-line mixer such as a static mixer that mixes the liquid just prior to depositing it into the container. The static mixer is preferably disposable.

In some preferred embodiments the liquid is a thermoset precursor. Optionally the thermoset precursor is cured by adding energy. Optionally the added energy speeds up the curing process. The thermoset precursor can be a single part thermoset precursor, a two part thermoset precursor or a more than two part thermoset precursor.

Thermosets can include silicone systems. For example room temperature vulcanizing (RTV) silicones such as tin catalyzed condensation silicones and platinum catalyzed addition cure silicones. Silicones can be one part RTV systems or two RTV systems. Other silicone systems include high temperature curing systems which can be one and two part silicones.

Single part thermosets also include photopolymers. Photopolymer systems can include binders; monomers (e.g., acrylate, epoxide and urethane monomers); photoinitiators; plasticizers, stabilizers, nano particles, reactive diluents (e.g., to form composite resins) and colorants. For example, photopolymers that are used in sterolithography can be utilized in the methods and equipment described herein. Binders are reactive molecules of medium molecular weight (e.g., 100-1,000 g/mol) consisting of a few monomer unites (e.g., dimers, trimers and trimers). Photopolymers can consist of between 50 and 80% of such binders. Binders can be styrene based such oligomers of styrene-tetramer-alpha-cumyl and, alpha-methyl styrene oligomers. Binders can be selected from the methacrylate family such as acrylic acid oligomers and methyl methacrylate oligomers. Binders can be vinyl alcohols such as vinyl alcohol trimers, vinylacetate trimers and vinylacetate oligomers. Binders can be olefins such as poly isobutylene. Binders can be selected from glycerols such as triglycerol. Binders can be polypropylene glycols such as poly propylene glycol. Monomers can be selected from acrylates, epoxides and urethanes. Some examples of monomers include, methyl methacrylate, ethyl methacrylate, bis-phenol A glycidyl dimethacrylate, triethylene glycol dimethacrylate, urethane dimethacrylate, trimethylolpropane trimethacrylate and ethoxylated trimethylolpropane triacrylate. Photo initiators can be cationic or free radical initiators. Some examples of photo initiators include onium salts, transition metal complexes, pyridinium salts, benzophenone, benzil dimethyl acetal, xanthones, quinones, benzoin ethers, acetophenones, benzoyl oximes and acylphoshines.

Thermosets include ring opening metathesis polymerization (ROMP) systems. Optionally the system is a one part system including a monomer and a catalysts with a high barrier to activation. In such a system the catalyst and monomer are stable for long enough to produce a part. The polymerization is initiated by providing thermal energy to the monomer catalyst mixture deposited in the container of the part that is being created.

Optionally, some ROMP systems are two part systems with one part including the monomer and the second part including the catalyst. For example the catalyst can include a carrier such as a solvent that dissolves or suspends the catalyst for easy mixing with the monomer. The monomer and catalyst are mixed just prior to filling the container or are mixed in the container (e.g., by the movement of the nozzle and or stage).

Preferably a two part ROMP system is used wherein, one part includes a monomer and catalyst precursor and the second part includes the monomer and activator. For example Schiff base bearing ruthenium catalysts combined with acid activators in the polymerization of dicyclopentadiene as described in U.S. Pat. Nos. 8,703,888 and 8,927,670 which are herein incorporated by reference in their entirety.

Monomers are strained unsaturated ring systems and can be selected from the group consisting of dicyclopentadiene, norbornadiene, substituted dicyclopentadiene, substituted norbornadiene, cyclooctene, cyclic olefins, vinylene-bridged ans-ferrocene and mixtures of these. Preferably the monomers is dicyclopentadiene.

The catalysts or catalyst precursor is selected from the group consisting of: 2,6-Diisopropylphenylimidoneophylidene molybdenum(VI) bis(hexafluoro-t-butoxide); 2,6-Diisopropylphenylimidoneophylidene molybdenum(VI) bis(trifluoromethanesulfonate) [activated by addition of appropriate alkoxide]]; dimethoxyethane Bis(tricyclohexylphosphine)[(phenylthio)methylene]ruthenium(II) dichloride; Tricyclohexylphosphine[1,3-bis(2,4,6-trimethylphenyl)-4,5-dihydroimidazol-2-ylidene][(phenylthio)methylene]ruthenium(II) dichloride; 2,6-Diisopropylphenylimidoneophylidene molybdenum(VI) bis(t-butoxide); Bis(tricyclohexylphosphino)-3-phenyl-1H-inden-1-ylidene ruthenium(II) dichloride; Bis(tricyclohexylphosphine) [(phenylthio)methylene]ruthenium(II) dichloride; [1,3-Bis(2,4,6-trimethylphenyl)-2-imidazolidinylidene]-[2-[[(4-methylphenyl)imino]methyl]-4-nitrophenolyl]-[3-phenyl-1H-inden-1-ylidene]; [1,3-Bis(2,4,6-trimethylphenyl)-2-imidazolidinylidene]-[2-[[(2-methylphenyl)imino]methyl]phenolyl]-[3-phenyl-1H-inden-1-ylidene]ruthenium(II) chloride; [1,3-Bis(2,4,6-trimethylphenylimidazolidin-2-ylidene)(tricyclohexylphosphine)-(2-oxobenzylidene) ruthenium(VI) chloride; Tricyclohexylphosphine[1,3-bis(2,4,6-trimethylphenyl)-4,5-dihydroimidazol-2-ylidene][(phenylthio)methylene]ruthenium(II) dichloride; Tricyclohexylphosphine[1,3-bis(2,4,6-trimethylphenyl)imidazol-2-ylidene][3-phenyl-1H-inden-1-ylidene]ruthenium(II) dichloride; 2,6-Diisopropylphenylimidoneophylidene molybdenum(VI) bis(t-butoxide); 2,6-Diisopropylphenylimido neophylidenemolybdenum(VI) bis(hexafluoro-t-butoxide); 2,6-Diisopropylphenylimidoneophylidene molybdenum(VI) bis(trifluoromethanesulfonate) dimethoxyethane adduct; Benzylidene-bis(tricyclohexylphosphine)dichlororuthenium, Bis(tricyclohexylphosphine)benzylidine ruthenium(IV) dichloride; (1,3-Bis(2,4,6-trimethylphenyl)-2-imidazolidinylidene)dichloro(phenylmethylene)(tricyclohexylphosphine)ruthenium, Benzylidene[1,3-bis(2,4,6-trimethylphenyl)-2-imidazolidinylidene]dichloro(tricyclohexylphosphine)ruthenium; [1,3-Bis-(2,4,6-trimethylphenyl)-2-imidazolidinylidene]dichloro(phenylmethylene)(tricyclohexylphosphine)ruthenium; (1,3-Bis-(2,4,6-trimethylphenyl)-2-imidazolidinylidene)dichloro(o-isopropoxyphenylmethylene)ruthenium; Dichloro(o-isopropoxyphenylmethylene)(tricyclohexylphosphine)ruthenium(II); Dichloro[1,3-Bis(2-methylphenyl)-2-imidazolidinylidene](benzylidene)(tricyclohexylphosphine)ruthenium(II); Dichloro[1,3-bis(2,4,6-trimethylphenyl)-2-imidazolidinylidene](benzylidene)bis(3-bromopyridine)ruthenium(II); Dichloro[1,3-bis(2,4,6-trimethylphenyl)-2-imidazolidinylidene](3-methyl-2-butenylidene) (tricyclohexylphosphine)ruthenium(II); Dichloro[1,3-bis(2-methylphenyl)-2-imidazolidinylidene](2-isopropoxyphenylmethylene)ruthenium(II); 1,3-Bis(2,4,6-trimethylphenyl)-4,5-dihydroimidazol-2-ylidene[2-(i-propoxy)-5-(N,N-imethylaminosulfonyl) phenyl]methyleneruthenium(II) dichloride; and [1,3-Bis(2,6-di-i-propylphenyl)-4,5-dihydroimidazol-2-ylidene]-[2-i-propoxy-5-(trifluoroacetamido)phenyl]methyleneruthenium(II) dichloride; and Dichloro[1,3-bis(2,4,6-trimethylphenyl)-2-imidazolidinylidene][3-(2-pyridinyl)propylidene]ruthenium(II)

Activators can be an acid such as a Bronsted or Lewis acid. Some examples of Lewis acid activators include aluminum chlorides, boron trifluoride and chlorosilanes. For example trichlorosilane is an effective activator. Bronsted acids such as mineral acids can be used. For example hydrochloric acid is an effective activator.

In some embodiments using ROMP systems an activator is incorporated with the material forming the container such as a thermoplastic. For example, the activator is added/applied as a coating or compounded with the thermoplastic or material forming the container. The liquid can then include a single component that contains the monomer and the catalyst.

Other kinds of liquids can be used in alternative embodiments. For example, liquids that can be cured to form allyl resins, epoxy resin, melamine formaldehyde, phenol-formaldehyde plastic, polyester, polyamide, polycyanurates, vulcanized rubber, and polyurethane. For example epoxy resins such as bisphenol A epoxy resin, bisphenol F epoxy resin, Novalac epoxy resin, aliphatic epoxy resin and glycidylamine epoxy resin. Liquids can also be used that are cured to form thermosets that are self-healing materials such as poly(urea-urethane).

In some alternative embodiments the liquid can be an edible material. For example, the material can be a batter for making a baked material such as brownies, cookies and cake. The liquid can be a food paste such as a butter (e.g., peanut butter, almond butter, sunflower seed butter). The paste can also be a meat paste such as a pureed beef, chicken, pork and/or fish. The liquid can also be an uncured or partially cured gelatin. The liquid can be a liquid protein containing material such as eggs (e.g., reconstituted egg whites). The liquid can also include added nutrients and vitamins such as iron and vitamin C. The liquid can also include pharmaceuticals.

In some further embodiments any of the materials (e.g., a thermoplastic and/or the liquid that is at least partially cured) can include added solids. For example, carbon, glass, ceramic, wood and plastic fibers and/or particulates can be added/compounded to a starting material to produce the part or support feedstock. For example, the added material can modulate the physical properties of the support or part (e.g., increase the stiffness and/or the toughness). Alternatively, for food based parts, the solids can include foods such as nuts and chocolate pieces.

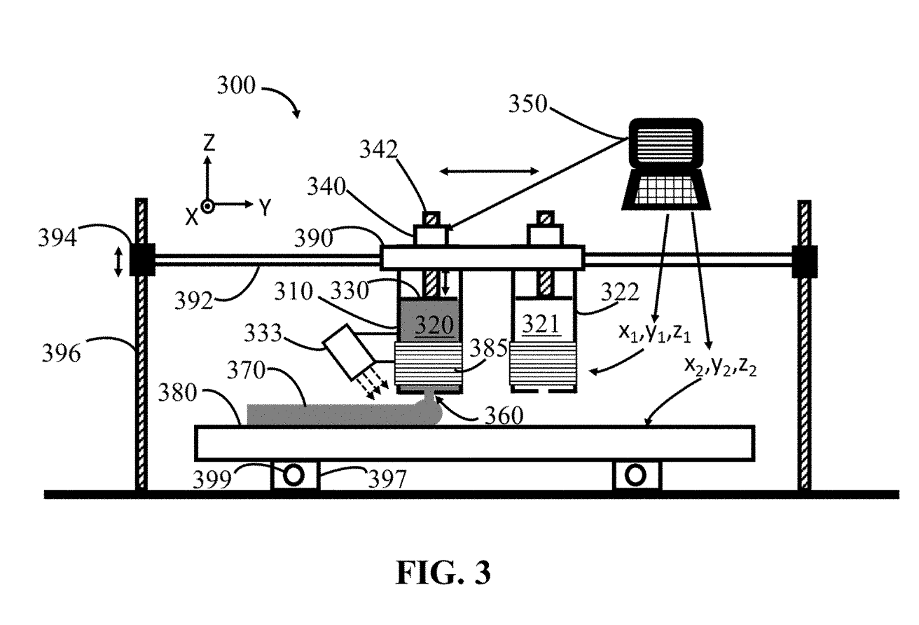

FIG. 3 is a diagrammatic front cross cut view of a 3D printer 300 having two extruders for producing a part, such as the part described in FIG. 1 and FIG. 2. For example, the printer can be used for printing parts using a paste 320 as the feed material in one extruder, and a liquid 321 as the feed in the other extruder. The printer includes a chamber 310 capable of containing the paste material 320. The printer also includes a second chamber 322 for containing the liquid 321. In this embodiment the chambers operate in a similar way and only the description for chamber 310 is provided. Embodiments including 1, 3, 4 or more chambers are also envisioned and it is understood that similar features as described are applicable to these embodiments. The chamber includes at least one movable wall 330. The walls can be made to move by a mechanical device 340 e.g., a linear actuator with a nut and a screw 342 in mechanical communication with the wall. For example, the wall can be made to move up and down in the Z direction as indicated by the double headed arrow next to screw 342. The mechanism 340 can be controlled by a CNC controlling device 350 such as a computer executing an algorithm. The chamber 310 also includes at least one opening 360 through which material 320 can be extruded to produce extruded material 370. A stage 380 is disposed to receive the extruded material from the opening (e.g., a first layer of extruded material is deposited on the stage with subsequent layers deposited on previously deposited material). The stage can include a heater. The relative position of the stage 380 and the opening 360 is controlled by the CNC control. A chamber heater 385 is disposed for optionally heating the chamber and material inside the chamber. The heater can be a silicone mat resistive heater and includes a thermocouple (not shown) for monitoring the temperature. Other embodiments include a hot air gun, an IR lamp, a resistive heater, and combinations of these directed at the chamber. In some embodiments the heater is made using a metal block such as aluminum that is machined to fit around the chamber e.g., with a hole through the metal, and wherein the metal is heated with a cartridge heater.

The CNC control communicates with electrical and mechanical devices that control the relative position of the chamber 310 (e.g., x₁, y₁, z₁), the stage 380 (e.g., x₂, y₂, z₂) and the heater 385 temperature. For example, stepper motors coupled to the stage or chamber through direct screw drives, belts and or pulleys. Gantries, tracks and other methods of smooth movement of the stage and/or chamber relative to each other in X, Y and Z directions can be used. A preferred algorithm executes a relative X and Y movement of the opening to the stage while extruding material, followed by an incremental movement up in the Z direction, and followed by deposition of another layer by relative movement in the X and Y directions and extrusion of additional material. It is understood that this algorithm may include pauses in motion, and motions in any direction, such motions can be used to allow inspection, adjustment, modification, or other actions to be performed on the part being printed or the apparatus. Pauses can also be for the purpose of curing or partially curing a part. A part is thus built by deposition in a layer by layer fashion. It is understood that the relative movement of the chamber and stage can achieved by many different configurations. For example, under CNC control and the electrical and mechanical devices, the stage may move in the X and Y direction and the chamber moves in a Z direction; in another configuration the stage may move in a Z direction and the chamber moves in an X and Z direction; alternatively the stage may move in a Y direction while the chamber moves in an X and Z direction; in another configuration the stage may not move and the chamber may move in X, Y and Z directions. The exact configuration for CNC movement can be selected by the Artisan. In some embodiments such as depicted in FIG. 3, the chamber can be relatively heavy since it supports all of the feed material for two chambers and linear actuators. Therefore, it may require a strong rigid structure made of metal (e.g., aluminum and/or steel).

FIG. 3 shows one possible configuration for movement using a gantry to move the chamber relative to the stage. The gantry has a carriage 390 that is fastened to the chambers. The carriage can move in the Y direction on rail 392. The rail is fastened to nut 394 which is coupled to screw 396 and therefore can move the chamber in the Z direction. Movement of the carriage and screw can be done using stepper motors coupled to the carriage and screw (e.g., direct drive for the screw, through a belt for the carriage). The stage can be moved in the X direction with a second carriage 397 and rail 399. Other configurations include a stage that does not move and a gantry with 3 orthogonal rails to move the chamber in X, Y and Z directions are conceived. In the shown embodiment the two chambers move together with the carriage (e.g., they are attached to each other and to the carriage). Alternate embodiments include an independent carriage and rail for each chamber so that the chambers can move independently of each other.

In some preferred embodiments, the printer 300 includes an energy source 333. The energy source can be attached to a chamber and configured to direct energy towards the extruded material. For example, as depicted in FIG. 3 wherein the dotted arrows represent energy directed towards extruded material. The CNC control can control the output of energy to optimize the effect on extruded material. For example, as shown in FIG. 3, as chamber 310 moves from left to right depositing extruded material, energy source 333 in active and provides energy to extruded material.

In preferred embodiments the chamber and movable wall are configured as a syringe, with the barrel of the syringe defining the chamber and the movable wall being the surface of the plunger placed inside the barrel. The syringes are therefore the extruders of the printer.

As previously described, the movable wall 330 can be moved by means of a linear actuator that is in mechanical communication and/or contact with the wall. For example, as shown in FIG. 3, the actuator is in contact on one side of the wall while the other side is in contract with the material. Although a screw and nut is depicted in FIG. 3, any suitable linear actuator can be utilized. Preferably the linear actuator can be selected from the group consisting of a screw and nut, a pneumatic or hydraulic piston, a solenoid, a wheel and axle or a cam. For example, by rotation of an actuator nut relative to a screw, the screw can move in and out of the threaded hole in a linear fashion (e.g., or the nut moves up or down the shaft). In an alternative, a wheel and axle can be coupled to a belt that is also connected to a rigid shaft and can move the shaft in a linear fashion. Also, a cam can be used to provide thrust at the base of a shaft.

Mechanisms other than a linear actuator are recognized for moving the walls of the chamber. For example, the Tube-Wringer® (Gill Mechanical Co., Oregon) acts by squeezing two walls of a flexible tube (e.g., configured as a toothpaste or caulking tube) between rollers. Such rollers could be modified to be driven by a motor and CNC controlled. Alternatively, more than one linear actuator could be used, for example, pushing on two walls of the chamber, such as opposing sides of a flexible tube.

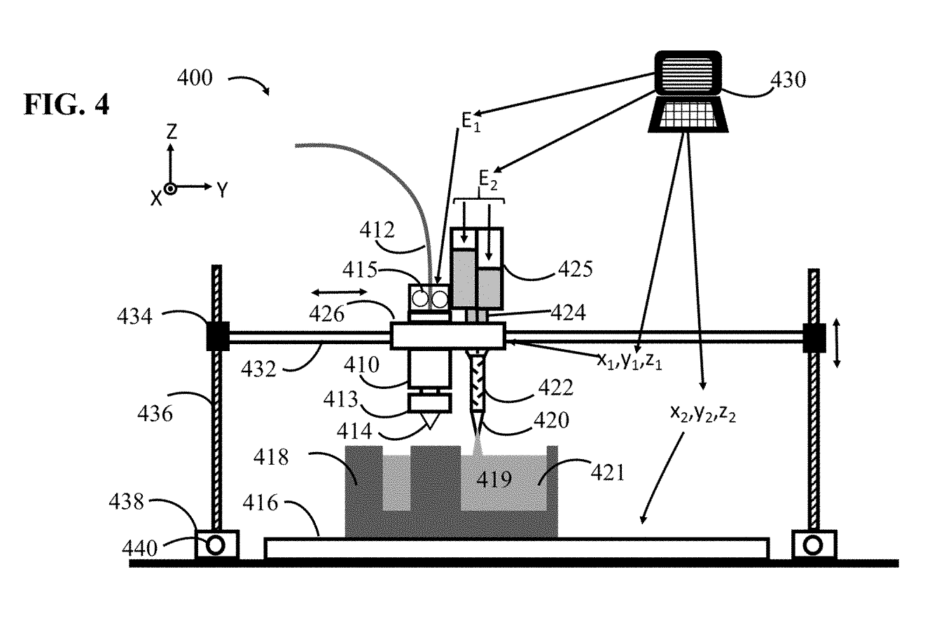

FIG. 4 is a diagrammatic cross cut front view of another 3D printer 400 for producing a part. For example, a part as described in FIG. 1 and FIG. 2. The printer includes a thermoplastic extruder 410. The thermoplastic extruder heats thermoplastic filament 412 using heater 413 which is forced through nozzle 414 by rollers 415 or gears coupled to a stepper motor. Molten filament can then be deposited onto stage 416 which is disposed below nozzle 414. The stage can include a heater. The thermoplastic is deposited in a layer by layer fashion producing a portion of a part 418 defining at least one container. (e.g., the first layer is deposited on the stage and subsequent layers on the previous layer of thermoplastic of the growing part). The 3D printer also includes a liquid extruder 420. In the shown embodiment the liquid extruder includes an in-line mixer 422 and dual reservoir chambers 425. The in-line mixer receives liquids through tubes 424 and mixes these liquids as they flow into and through the in-line mixer. The tubes are connected (e.g., so as to be in fluid communication) to chambers 425 for containing liquids. The chambers each include a movable wall for pressurizing the liquids and forcing the liquid through tubes 424, through static mixer 422 and through extruder 420. The liquid, when mixed in 422, becomes a curable liquid 419 and it is deposited into the containers such as 421 in part 418 where it can cure at least partially. The thermoplastic and liquid extruder are attached to a carriage 426. The apparatus includes a computer control system CNC control 430.

The CNC control communicates with electrical and mechanical devices that control the relative position of the extruder carriage 426 (e.g., x₁, y₁, z₁), the stage 416 (e.g., x₂, y₂, z₂) and the heater 413 temperature. For example stepper motors coupled to the extruder carriage through a gantry system including rail 432, nut 434, direct drive screw 436, carriage 438 and rail 440. In the shown configuration the stage does not move while the extruders are being operated. The CNC control also controls the extrusion speed of thermoplastic E₁ and the liquids E₂.

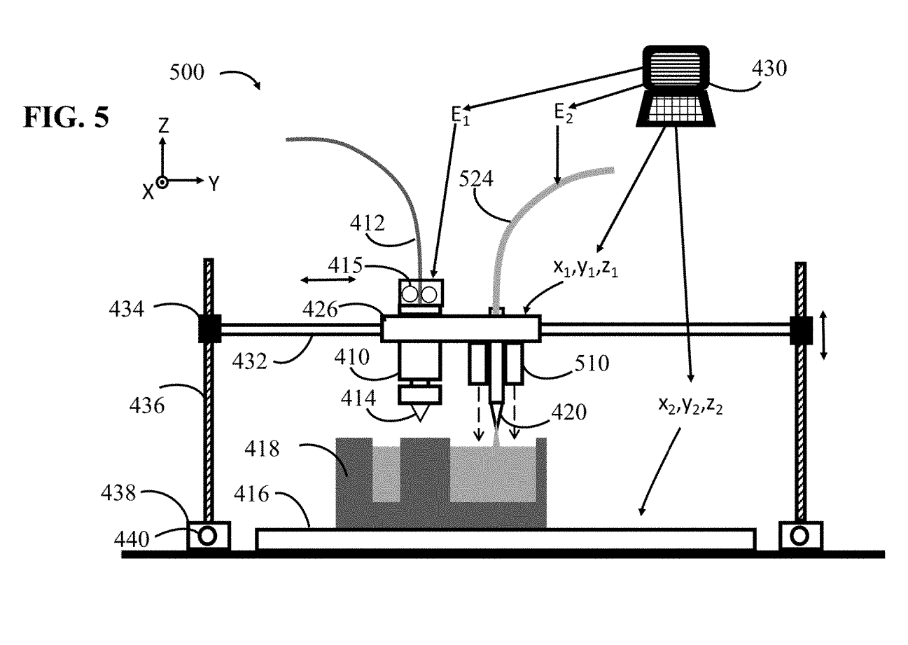

FIG. 5 is a diagrammatic front cross cut view of a 3D printer 500 with a filament and a liquid extruder including a curing device. The printer includes an energy source 510 attached to carriage 426 and disposed to direct energy (e.g., shown as dotted arrows) at the extruded liquid. The energy source is a removable and interchangeable. The type of energy source selected depends on the kind of curable liquid that is used. For example, if a photo curable polymer is used the energy source can be a UV or visible light/laser. If a heat curable polymer is used then an energy source such as a resistive heater, a hot air gun or an IR lamp could be appropriately selected. The curable liquid is conveyed to the extruder 420 through a tube 524, the flow therethrough controlled by the CNC control computer 430. The tube is fed liquid from a reservoir such as a chamber with a movable wall (not shown).

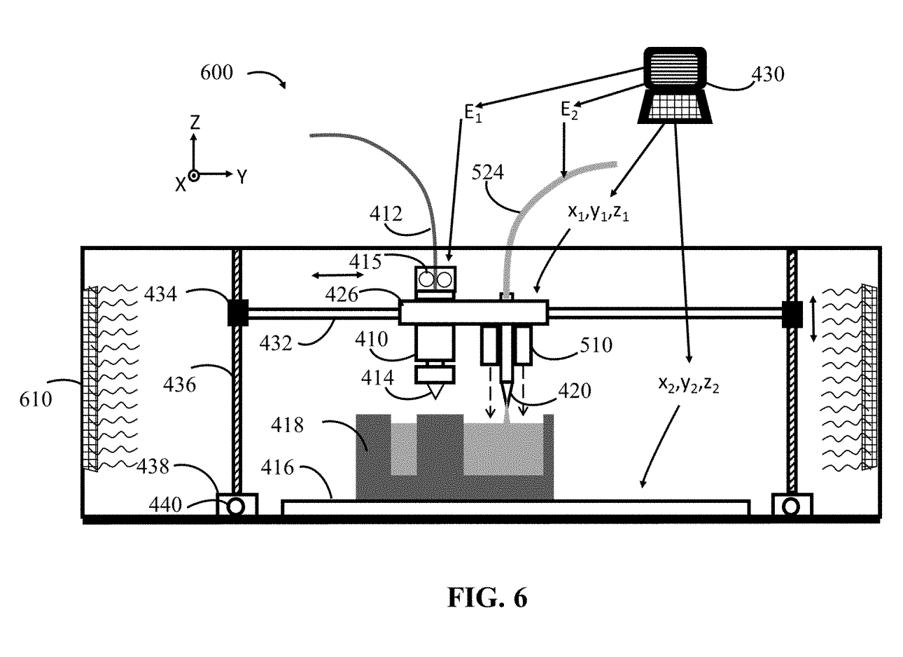

FIG. 6 is a diagrammatic front cross cut view of a 3D printer 600 including an insulating enclosure and heaters. In this embodiment the 3D printer includes a heated insulation enclosure for maintaining the extruded materials at a temperature of at least about 35 degrees Celsius (e.g., at least about 40 degrees Celsius, at least about 50 degrees Celsius, at least about 60 degrees Celsius, at least about 70 degrees Celsius, at least about 80 degrees Celsius, at least about 90 degrees Celsius, at least about 100 degrees Celsius, at least about 120 degrees Celsius). This can be effective for some curable liquids such as dicyclopentadiene which have freezing points around room temperature. The insulated enclosure can also aid in curing heat curable liquids. The insulation is configured as an insulating chamber containing the stage and part. The chamber also includes heaters 610. The 3D printer can also include heating elements for tube 524 such as a heating tape to maintain the temperature above the melting point of the liquid. The heater and insulated chamber can even maintain temperatures of at least about 35 degrees Celsius (e.g., at least about 40 degrees Celsius, at least about 50 degrees Celsius, at least about 60 degrees Celsius, at least about 70 degrees Celsius, at least about 80 degrees Celsius, at least about 90 degrees Celsius, at least about 100 degrees Celsius, at least about 110 degrees Celsius, at least about 120 degrees Celsius).

In some embodiments, more than one paste (e.g., molten thermoplastic) or liquid are utilized in creating the part. For example, ABS and Nylon are used as a thermoplastic. As another example, dicyclopentadiene and a silicone are used to fill the containers. In these embodiments additional extruders for the pastes and liquids can be used, the extruders can be similar to those described herein. Also additional equipment, such as energy sources can be used. For example, a heater and a UV-lamp might be used depending on the liquid used.

In some embodiments the printing is done under a reduced oxygen environment. For example, an environment that does not support combustion of any organic regents that are used such as monomers and polymers. Some reduced oxygen environments include a gas mixture with more than 90% nitrogen, argon, carbon dioxide and or helium). The reduced oxygen environment can be achieved by enclosing the 3D printer and flushing the enclosure with a gas including nitrogen, argon, carbon dioxide, helium or mixtures thereof. A low oxygen environment can be maintained by recirculating the atmosphere through a catalyst such as a copper based catalyst. For example, the enclosure can be a glove box. The enclosure can be designed as a part of the 3D printer. The enclosure can alternatively or additionally provide a reduced moisture environment such that a dry gas mixture contains less than the saturation amount of water for the temperature and pressure (e.g., less than about 30 g water/Kg air at 1 atm, less than about 25 g/Kg, less than about 20 g/Kg, less than about 15 g/Kg, less than about 10 g/Kg, less than about 5 g/Kg or less than about 1 g/Kg). The reduced moisture environment can be maintained by flushing the enclosure with a dry gas and/or removing moisture through a recirculating drying system (e.g., the drying system using molecular sieves).

The methods and equipment described herein are useful for making a part which is also an embodiment of the invention. For example a 3D printed part can be configured as a thermoplastic shell surrounding a core where the core is selected from the group consisting of a thermoset polymer and a composite comprising a thermoset polymer. For example, the thermoset polymer can be any one or more thermoset herein described. The part can also include a solid such as fiber glass, carbon fibers, wood fibers and other materials such as have been described herein. The part can also have void volumes between about 5% and 95%. The part can be made in many different configurations, for example as a component of a vehicle, an airplane component, a body armor component, a mechanical device or component, a medical device or component, a structural support for a building, a micro-mechanical device, a body replacement part or prosthesis, a disposable component or a sensor part.

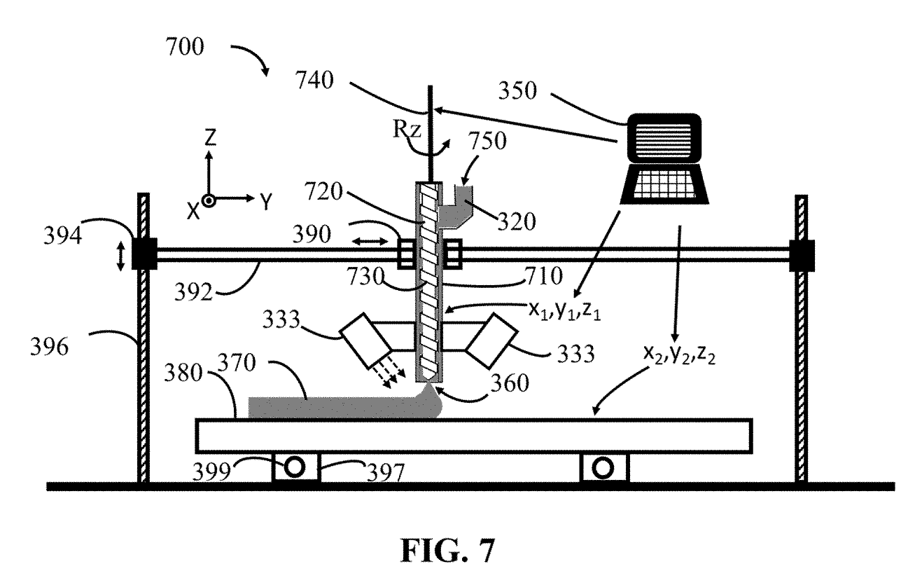

FIG. 7 exemplifies another embodiment of a 3D printer 700 wherein the movable wall can be the screw of an extruder. For example the screw extruder (shown as a cross cut view) has a chamber 710, containing the screw 720. The flights of the screw comprise a moving wall 730 in the chamber. A mechanism for moving the screw (e.g., the wall) can be a rotatable shaft 740, e.g., rotating in the direction indicated by curved arrow Rz. A drive motor can be coupled to the shaft to have it rotate around its axis (the drive motor is not shown). The rotation speed can be controlled by the CNC controller 350. The extruder can be continuously feed through an extruder ingress 750, for example where the ingress is coupled to a feed-hopper, a syringe, a peristaltic pump, a progressive cavity pump or another screw extruder. Other features are the same as indicated in FIG. 3; Material 320 in the chamber 710, extruded material 370, opening 360, stage 380, gantry with carriage 390, rail 392, nut 394, screw 396, rail 399 for the stage, Energy source 333 and carriage 397. A chamber heater can also be included (not shown), for example, a heating tape can be wrapped around the chamber wall. In some alternate embodiments the 3D printer can include multiple extruders (e.g., 2, 3, 4 or more) and the extruders can be configured as any of the extruders herein described.

Any of the openings of the chambers such as 360 can be attached to a nozzle. For example, the nozzle can be a removable part with different size outlets. Material is fed into the nozzle through an inlet and out of the nozzle through on outlet. In some embodiments two or more chambers (e.g., two screw extruders, two syringe extruders or a screw extruder and a syringe extruder) are used and each chamber feeds the material to be extruded through an opening in each chamber, to the nozzle inlets. Therefore, between the outlet of the chambers and the nozzle inlets the two materials combined prior to being extruded through the nozzle. The location or region where the combination occurs is an in-line mixer. For example, with two chambers, the mixer can be in a “Y”-shaped configuration wherein the mixing chamber has two inlets connected to the outlets of the chambers and one outlet connected to the nozzle inlet. The size of the inlets to the chamber can be each of different sizes, for example to control the amount of material from each chamber allowed into the mixing chamber. The chamber can be an elongated tube, elliptical, rectangular, conical or any other suitable shape. Mechanical mixing such as rotating propellers, paddles, rotor stators and/or turbines can be used to improve the mixing. Mechanical stationary means such as a static mixer can also be used. Preferably, a static in-line mixer is used.

As previously described the 3D printers can preferably include an energy source directed at the extruded material. Such an energy source can be useful for curing the material. For example, it can be beneficial to cure or partially cure the material as soon or soon after it is deposited, since this will diminish any flow of the material which can distort the final part. For example, if the material is deposited as a tube with a diameter of 1 mm, curing can prevent the diameter from distorting by more than about 10% (e.g., a distortion forming roughly an ellipse with the major axis not greater than 1.1 mm or the minor axis of not smaller than 0.9 mm). As previously described, the energy source can be attached to the chamber or to a structural support for the chamber so that it moves with the chamber and can be directed to the area where the material is being deposited on the stage. Alternatively or additionally the energy source can be attached to the stage and can be configured to direct energy to the deposited material. Alternatively or additionally, the energy source can be independent of the stage and chamber and simply positioned or controlled (e.g., controlled by the CNC control) to direct energy towards the deposited material. The energy source can also be a UV or visible light source. A UV or visible light source can be used, for example, to initiate a photo polymerization. The light source can be a laser light, for example, such as is used in sterolithography. More diffuse light can also be utilized. In some embodiments the energy source can be a source that provides ionizing radiation, for example, an electron gun.

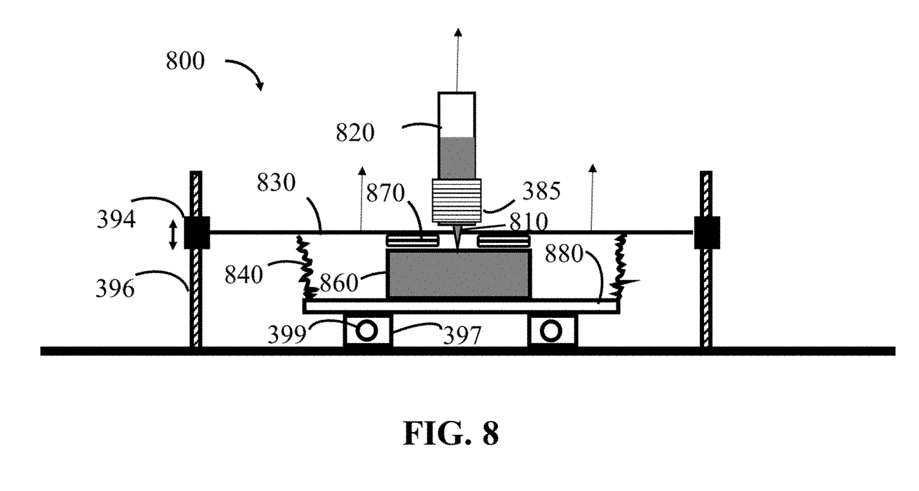

The energy source can be a source that provides heat. For example, the energy source can be heat supplied from the stage, for example through resistive heaters. In addition, or alternatively the heat can be supplied by a heat gun disposed to blow hot air at the extruded material as it is being deposited and/or where it has been deposited. Similarly, the heat source can be from an IR lamp. If the energy source is a source that supplies heat, the 3D printer can include insulation. For example, the entire 3D printer including the heat source can be enclosed with an insulating material. The 3D printer can be configured as an oven where the material can cure as it is being printed. In some embodiments, the chamber containing the material to be extruded is not in the heated or insulated region. For example, only a nozzle attached to the chamber is substantially in the heated or insulated region. For example, a heat insulating flexible shroud can be used that moves up with the nozzle as depicted for 3D printer 800 in FIG. 8. The nozzle 810, is attached to the chamber 820 and a support 830. Flexible walls 840 hang down from 830 and are optionally attached to the edges of the stage 880. Therefore, the flexible walls, support and stage enclose a space containing the part. The flexible walls are designed so that they can be stretched and extended as the part 860 is printed and as the nozzle, chamber and rigid top move up relative to the stage as indicted by the arrows. An energy source, for example, 870, can be attached to 830 and irradiate the sample. The energy source can be annularly arranged about the nozzle. In the embodiment shown with reference to FIG. 8, the stage moves in the X and Y direction while the chamber moves in the Z direction.

In some embodiments, a thermally insulating material can be extruded using a second extruder and deposited around the part that is being printed. For example, an insulating foam. The insulating material can be in contact with the part or offset and surrounding the part.

In some embodiments it is preferable to be able to maintain the part that is being printed at an elevated temperature for the duration of the print. For example, for curing a heat curing silicone and/or epoxide. For example, the temperature can be selected to aid in curing the particular material such as maintaining the part at a temperature at least about 35 degrees Celsius (e.g., at least about 40 degrees Celsius, at least about 50 degree Celsius, at least about 60 degree Celsius, at least about 70 degree Celsius, at least about 80 degree Celsius, at least about 90 degree Celsius, at least about 100 degree Celsius, at least about 110 degree Celsius, at least about 120 degree Celsius).

It can be advantageous to further cure a printed material after the printing is completed and the extruded material (e.g., 370) is partially cured. In some embodiments, e.g., for throughput enhancement, it is preferable to remove the material from the printer and cure the material in a curing environment, for example an oven or an irradiation chamber. Since removing the printed part prior to it being fully cured can damage/distort the part, it can be preferable for the 3D printer to include a stage that is at least partially removable. The part can therefore be removed with the stage and a new stage can be set in the 3D printer so that it can be utilized to print another part while the first part is cured. For example, the stage can be configured as a baking or cookie sheet.

The 3D printer can further include one or more additional extruders for printing a support material. For example, the one or more additional extruders may be thermoplastic extruders or paste extruders. For example the support material can be a material that can be printed to provide support to an overhang in the part and then be easily removed once the part is printed and/or has been cured. In some embodiments the support material is a thermoplastic that can be melted and removed from a thermally stable part (e.g., a part that does not melt under conditions where the support melts, or where the melting point of the part is higher than the melting point of the support). Optionally the support can be dissolved using a suitable solvent. For example, ABS plastic is dissolvable using acetone. In other embodiments the support material can be an uncured ceramic material such as a mineral clay. The clay is preferably not heated to a high enough temperature to have it fully cure. The clay can be dried, for example due to heating, after which it can be removed by shattering or brushing and washing off. Polymer clay material can also be used. Polymer clays may cure at a low temperature in which case, if they cure, they can be removed by shattering away from the part. In other embodiments the support material can be a starch or cellulose based material such as rice flower, wheat flower, cellulose powder (e.g., or combinations of these) optionally combined with a viscosity modifier such as xantham gum and a liquid such as water and/or an alcohols (e.g., ethanol).

The support material can be a brittle material relative to the part material when the support material is removed from the part. For example, the support material can be a material that has a toughness below about 0.1 KJ/m² (e.g., less than about 0.05 KJ/m², or even less than about 0.01 KJ/m²) while the part has a toughness greater than about 0.1 KJ/m² (e.g., greater than about 0.5 KJ/m² or even greater than about 1 KJ/m²).

In some embodiments the part material is more resilient than the support material. For example the part material is at least 10 times more resilient than the support material. Preferably the part material is at least 100 times more resilient than the support material or even more than 1000 times more resilient. Ceramics such as cured clay can have a Young's modulus of between about 10 and 50 GPa and a yield stress between about 50 and 140 MPa. Silicone elastomers have a Young's modulus between about 0.005-0.02 GPa and yield stress between about 2.4 G and a yield stress of between about 18.5 and 51 MPa. Using the formula: Resilience=2×(yield stress)/(Young's Modulus); bricks have a resilience between about 10⁻¹² and 10⁻¹⁰ Pa, silicone elastomers have a resilience between about 10⁻⁸ and 10⁻⁶ Pa and ABS thermoplastics have resilience between about 10⁻¹² and 10⁻¹⁰ Pa.

In some embodiments the support material can be stiff relative to the cured or partially cured material. For example the support material can have a Young's Modulus above about 0.1 GPa (e.g., above about 0.5 GPa or above about 1 GPa) while the cured or partially cured part can have a Young's modulus that is below about 0.1 GPa (e.g., below about 0.1 GPa). In some preferred embodiment the part, when cured or partially cured has a Young's modulus that is between about 0.001 and about 0.1 GPa (e.g., between about 0.001 and about 0.01 GPa,); and the support has a modulus between about 0.1 and about 100 (e.g. between about 0.5 and about 50).

The extruder for extruding support material can include an energy source, for example, which may be the same or different from the primary extruder. For example specifically chosen for curing the support material. For example, if the support material is a polymer clay material that is cured by heating, the energy source can be a heater set to heat at about the curing temperature of the polymer clay.

In some preferred embodiments the 3D printer can print using materials with very high viscosity. For example, materials with uncured viscosities greater than about 1 million centipoise, greater than 2 million centipoise or even greater than 10 million centipoise. For example, the 3D printers can print using two part silicones, one part caulking compounds and even materials with viscosities similar to window putty. For example, high temperature silicones such as MachBloc™ (Cortape Nebr., Inc.) can be printed.

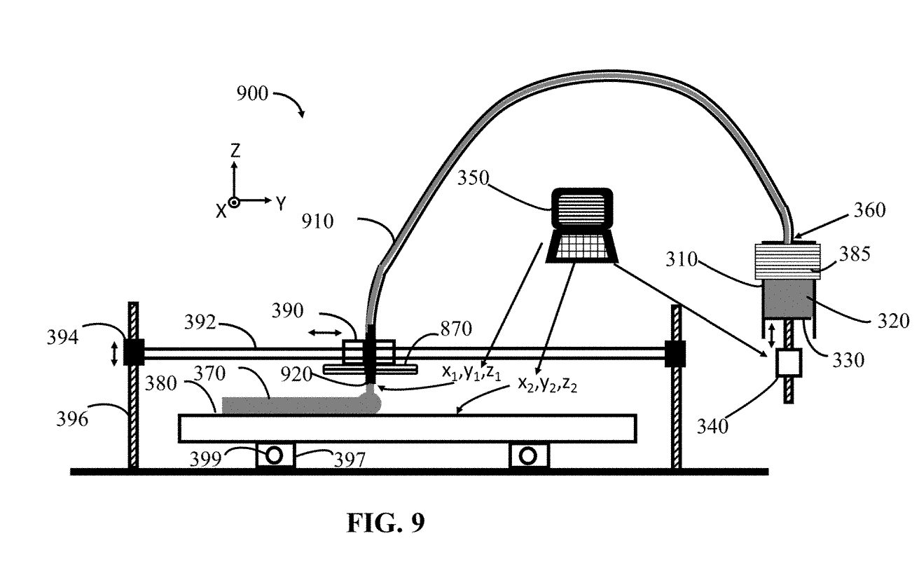

FIG. 9 is a diagrammatic front cross cut view of a 3D printer 900 including a tube for conveying material to the 3D printer stage. The printer includes many of the features previously describe such as chamber 310, material 320, movable wall 330, device 340, CNC control 350, opening 360, extruded material 370, and stage 380. The opening to the chamber 360 is attached to a tube 910 at its proximal end while the distal end of the tube 920 is disposed close to the stage 380. Preferably, the tube has some flexibility so that the end of the tube 920 can move while the chamber remains stationary. The end of the tube is supported by conventional structures, for example by being fastened to a carriage of a gantry system. In some embodiments the tube moves in one or more directions of X, Y and Z (e.g., X, Y, Z; X and Y; X and Z, or Y and Z) while the chamber is stationary. The end of tube 920 coordinates x₁, y₁, z₁ relative to position of stage 380 x₂, y₂ and z₂ are controlled by the CNC controller. Material is extruded from the chamber through the chamber opening, through the tube and out of the distal end. The chamber can be the screw extruder type described in FIG. 7 or a progressive cavity pump. More than one chamber can be utilized as well as mixers (e.g., in line mixers). Multiple chambers with tubes 910 (e.g., two or more) can also be used, for example with a mixing chamber attached to the distal end of tubes 910. Energy sources, such as heater 870 attached to the carriage 390 can also be used, for example, to cure the extruded material.

Other embodiments include attachment of a non-flexible tube to the chamber opening, the distal end of the tube being disposed above a stage for receiving extruded material. In this embodiment the chamber and distal end of the tube do not move relative to each other while printing a part, rather the stage moves.

The tube in the above embodiments can be temperature controlled. For example, the tube can be cooled with a cooling loop or jacket. The tube can also include a rupture disk or pressure release valve. In embodiments wherein two or more chambers are used, a mixer can be used. For example a tube connected to each chamber can be connected to an in line mixer. Alternatively the chambers can be connected directly to a mixer and a long tube then connected to the outlet of the mixer at the proximal end of the tube and the distal end disposed close the stage of the 3D printer.

Material construction for the chambers (e.g., the extruders) reflects the desired property of the printing material. For example, thick walls and/or metal construction are contemplated in applications for extruding medium and high viscosity materials. For example, chamber walls and tubes can be made out of stainless steel or alloys such as Hastelloy™ (Haynes International, Inc.). In some preferred embodiments, the chamber and tubes for flowing material at high pressure are rated to withstand an internal pressure of at least 2000 psig (e.g., at least 3000 psig, at least 4000 psig, at least 5000 psig, at least 6000 psig, at least 7000 psig, at least 8000 psig, at least 9000 psig). For example, the chamber, when sealed (e.g., the opening is sealed) and the movable wall is compressed, can withstand the above mentioned pressures.

A rupture disk can be integrated at any point designed to withstand high pressures for safety to operators and the equipment. For example, a chamber for containing a liquid or paste material or any part of the apparatus that is in fluid communication with the chamber and potentially under high pressure. Optionally or additionally, a pressure release valve can be utilized. The pressure release valve can be used for safety and/or it can also be used to avoid unwanted extrusion of material due to pressure buildup in the chamber.

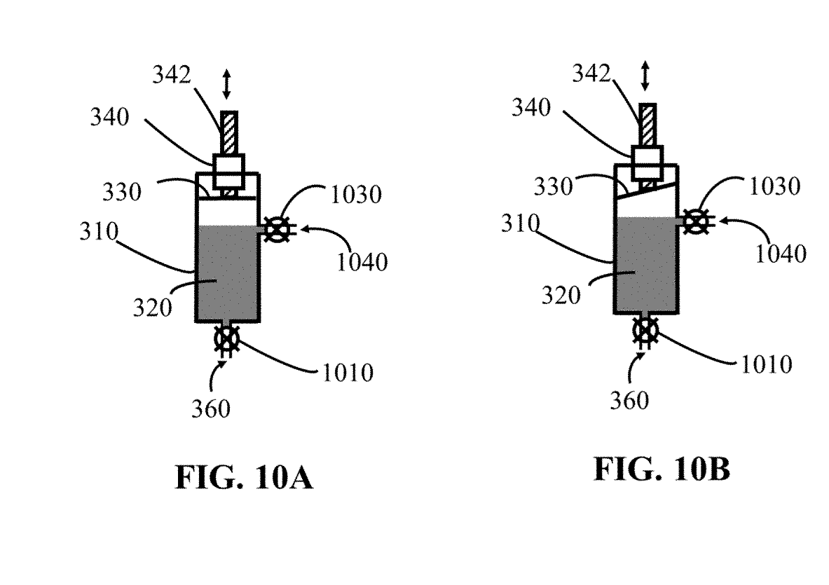

In another embodiment, a release valve is used to allow removing of gases from the chamber. FIG. 10A shows an embodiment with two valves 1010 and 1030. The valve 1030 can be opened while leaving valve 1010 closed. Movement of the chamber wall 330 towards the material 320 forces any gas trapped between the material 320 and wall 330 out of the opening 1040. Subsequently, the valve 1010 can be opened and valve 1030 can be closed. Movement of the chamber wall downwards (e.g., compressing material 320) forces the material through opening 360. Other configurations include having the wall slanted or curved. For example as shown in FIG. 10B, the wall 330 is not perpendicular to the movement of screw 342 as depicted by the double headed arrow. The valves 1010 and 1030 can be controlled by a device such as CNC controlling device 350 (shown in previous figures). The valves can also act as pressure release valves e.g., opening when a critical pressure is detected in the chamber by a pressure detector or opening at a particular time of the print to avoid oozing onto the stage.

In the operation of the 3D printers fully curing of the feed material in the extruder (e.g., the chamber, tubes connected to the chamber, mixers and nozzle) is preferably avoided. Some parts of the 3D printer are preferably easy to maintain by making them easy to remove, clean and/or replace. For example, in some embodiments a nozzle for extruding material and mixing chambers are disposable. For example, disposable static mixers are available from Stamixco (Switzerland) such as helical disposable static mixers. The nozzles can be configured as easily attachable flat nosed needle tips, such as luer lock attachable needles or configured similar to Eppendorf pipette tips. The interior of the chamber can also include a liner that can be removed. For example, the feed material can be provided as a replaceable cartridge that is inserted into the chamber, once the material is extruded out of the cartridge, the cartridge is removed and discarded or recycled/recharge. A cartridge for silicone can, for example, be made of plastic and/or cardboard and fit into the chamber. Alternatively, the equipment (e.g., the chamber, tubes and nozzles that contact feedstock) can be made to be easy to clean, for example, made of a material that can withstand a cleaning environment such as organic solvents, flame, high temperatures, sonication, concentrated acids and/or concentrated bases.

In some preferred embodiments the chamber can be sealed when it is not in use for extruding material. For example, the outlet can be coupled to a valve (e.g., a needle valve, one way valve) or stopcock that can stop any flow of material into the chamber (e.g., air and/or moisture). Inlets can also be sealed to isolate the material in the chamber. In some embodiments the chamber can also be easily removed from the 3D printer for storage purposes, cleaning or disposal; and so that a different chamber, for example containing a different or newer feedstock, can replace the removed chamber. Any tube attached and in fluid communication with the chamber can also be isolated similarly (e.g., with valves and/or stopcocks).

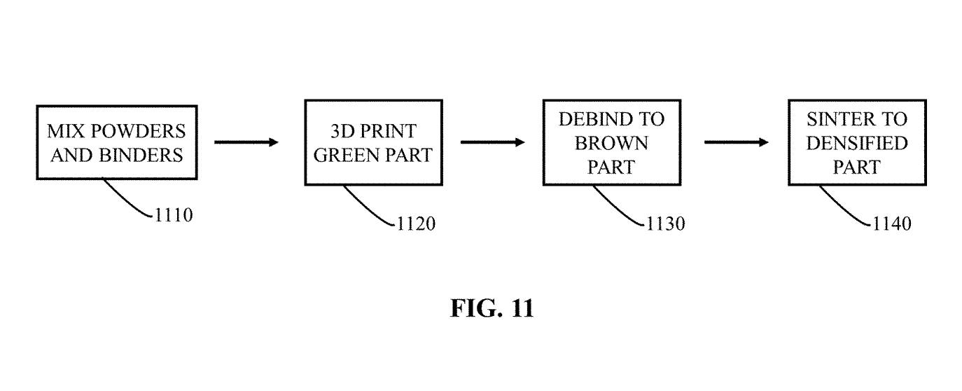

In addition to the above embodiments, the equipment, methods and systems described above, and illustrated in FIG. 1-10 can be used for making metal, ceramic and cermet parts. FIG. 11-13 illustrate embodiments for making metal, ceramic and cermet parts.

FIG. 11 is a flow diagram for a method to make a metal, ceramic or cermet part. The method includes mixing metal powder and binders in step 1110. The metal powder/binder mixture are then printed 1120 to produce part comprising metal powder and binder, which is referred to as a “green” part. The green part includes the metal powder and binder mixtures but will have the form of a desired part. The green part is held together mostly due to the fusion of the binder mixture within the part. A debinding step 1130 removes at least a portion of the binder leaving a part comprising metal and which is substantially depleted in binder, which is referred to as a “brown” part. The debinding step need not remove all the binder put produces a more porous structure through which gases can escapes during any further heating. The brown part is then sintered 1140. The method is applicable to making ceramic parts for example by replacing the metal particles in step 1110 with ceramic particles such as metal oxides, metal nitrides and metal carbides. The method is also applicable to making cermet parts for example by combining metal and ceramic particles in step 1110.

During the mixing step 1110 metal powder (e.g., and/or ceramic particles), binders and optionally other additives can be mixed at elevated temperatures (e.g., 120-200° C.). Without being bound by any specific theory, it is believed that heating melts the binders and optional additives so that they are in a liquid state and can coat the metal powders.

Metal powders can be made from any metal and include metal alloys. For example, metal powders that are used in metal injection molding and powder metallurgy including micro-powder injection molding can be used. For example metals selected from the group consisting of iron, nickel, chromium, zinc, cobalt, titanium, cadmium, molybdenum, tungsten, copper, gold, lead, aluminum, magnesium, manganese, silver, tin, platinum, palladium, iridium, rhodium, ruthenium alloys of these and mixtures of these. Metal powders can also be substituted by ceramic powders such as metal oxides (e.g., alumina, silicon oxide), nitrides (e.g., silicon nitride, tungsten nitride, titanium nitride), carbides (e.g., silicon carbide, tungsten carbide) and combinations of these (e.g., titanium carbonitride) can be used. Mixtures of metal powders and ceramic powders can also be used, e.g., to make Cermet objects. Metal and ceramic powder sizes can be selected so that they are at least 10 times smaller than the minimum feature size of the final sintered part. The particle size also should be at least smaller than any opening the particle flows through such as an extruder nozzle (e.g., at least half the size, at least ⅕^{th} the size, at least 10 times smaller). For example, average particle sizes can range widely for example being between about 0.1 and about 100 microns although preferred particles sizes are between about 1 and about 50 microns. Spherical, lozenge shaped, fibrous, dendritic and irregular shaped particles can be utilized. Spherical shaped particles show preferable flow properties while more irregular shaped particles can form stronger green part and/or brown part.

Binders can be selected from thermoplastics such as mixtures of one or more low molecular weight polymers, waxes or oils (e.g., paraffin wax, palm oil or polyethylene glycol) and one or more high molecular weight polymers (e.g., high density polyethylene, linear low density polyethylene, polypropylene or poly (ethylene vinyl acetate)). In addition water soluble binders (e.g., polyethylene oxide), acid degradable binders and base degradable binders can be utilized. Other binders can include natural polymers such as starch (e.g., tapioca starch), poly(ethylene-co-acrylic acid), ethylene-diene-propylene (EPDM), polybutenes, polystyrene, poly(methyl methacrylate), poly(vinyl butyral), polyacetal, methyle cellulose and polyamides.

Additives can be surface active agents such as long chain alcohols, carboxylic acids, amines, sulfonates and phosphonates. Other surface active agents include block co-polymers such as ethylene oxide-polyethylene oxide copolymers. For example stearic acid, steryl alcohol, oleic acid and oleyl alcohol can be used as additives and can improve compatibility between the metal powder and binder.

Mixing of the powders and binders can provide a homogenous combination of the powder and binder and ensure the metal and/or ceramic particles do not separate from the binder upon re-heating and melting such as during extrusion through a heated nozzle. Preferably, the powder and binder combination have a melting point below about 200° C. and have a melt viscosity below about 10 pascal-seconds (Pa-s). In some embodiments the metal powder/binder mixture is pelletized.

During the printing step 1120 the mixture produced in step 1110 can be used in a printer as described above. Some additional embodiments of printers and methods are described below.

During the debinding step 1130 at least a portion of the binder and additives are removed from the green molded part. For example, this can be done by heating the green part, chemically degrading the organic binders/additives or subjecting the part to solvent extraction. Heating to moderate temperatures (e.g., below 400° C.) can melt or, in an oxidizing atmosphere, burn off the binders. Solvent extraction removes the binders/additives through dissolution of the organic binders and additives. The solvent utilized during the extraction depends on the binders and additives and can include water (e.g., neutral, acidic or basic) or organic solvents (e.g., alcohols, acids, ketones, aldehydes, esters, hydrocarbons, aromatics, mixtures of these). Debinding solvents can also include supercritical solvents such as supercritical CO₂. Debinding produces what is known as a “brown” part which is a weak brittle part with a large (e.g., greater than about 10%) void volume. As noted, debinding need not remove all the binders and additives since residual organics can be removed during the initial stages of the next step, the sintering stage.

Sintering 1140 can include heating to high temperatures (e.g., at least about 400° C., at least about 600° C., preferably at least about 700° C., such as at least 1000° C.). Sintering is preferably done in an oxygen-free or reducing atmosphere and/or in the presence of a reducing agent. For example, the oxygen-free atmosphere can be argon, nitrogen, helium or mixtures of two or more of these with less than about 1 vol % oxygen. A reducing atmosphere can include having hydrogen present in the atmosphere. A reducing agent can be used such as carbon, for example activated carbon upon which the brown part is placed. Sintering can produce a part with a density of at least about 97% (e.g., having less than about 3% void volume).

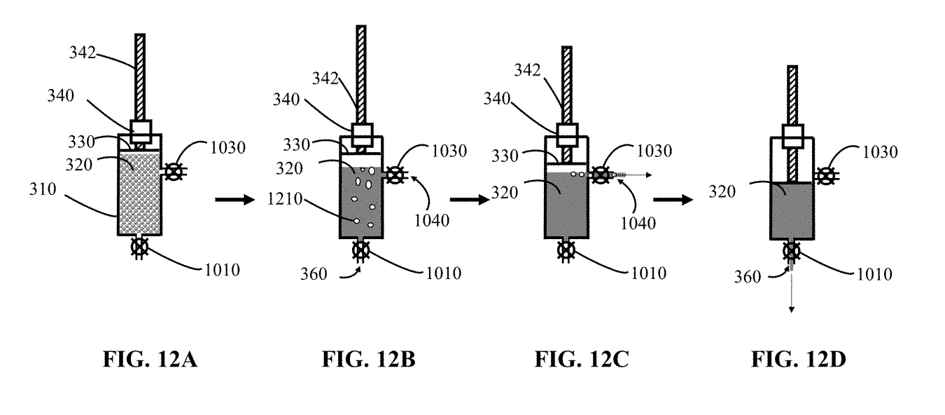

FIG. 12A-12D is a pictorial flow diagram showing cross cut views of chambers for extruding materials and how to remove air therein before extrusion. The feedstock 320 can be a metal/binder, ceramic/binder or cermet (e.g., metal and ceramic)/binder combination as previously described (e.g., metal and thermoplastic powders mixed together). FIG. 12A shows the feedstock loaded into the chamber 310 (e.g., a syringe extruder). The valves 1030 and 1010 are closed and the chamber is heated so that it melts as shown in FIG. 12B. As the material 320 melts, any trapped air bubbles, 1210, move upwards towards the top of the chamber and collect in the headspace between the movable chamber wall 330 and the molten feedstock 320. Optionally, vibration can be applied to the chamber such as by using a vibratory transducer or a sonicator e.g., to aid in having gases migrate to the headspace. In a subsequent step shown by FIG. 12C, valve 1030 is opened to allow the headspace gas to be pushed out of the chamber. For example, movable wall 330 is moved towards the molten material 320 forcing gas 1210 out of opening 1020 as indicated by the arrow. As shown in FIG. 12D, once the gas has been removed, valve 1030 is closed, valve 1010 is opened, and material can extrude through opening 60 as depicted by the arrow. Green parts are then made as previously described. This method and apparatus can be used for loading and degassing any material comprising a thermoplastic such as plastics and foods that can be melted (e.g., chocolate, caramel, fats, icing and fondants). Likewise liquids can be degassed using this method and apparatus except that heating may not be required or desired (e.g., heating would not be desired if the material is a heat curing material).

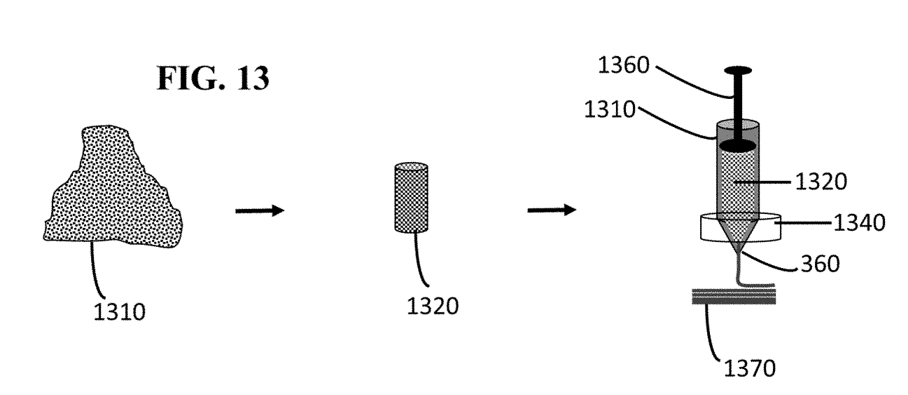

In another optional embodiment for making metal, ceramic or cermet parts the powder/binder precursor is initially formed into a part that can fit into the chamber (e.g., the chamber 310). For example, the initially formed part is made to be commensurate in size to the internal volume of the chamber. FIG. 13 shows an embodiment for producing an initially formed part in the shape commensurate with a chamber 1310 in the form of a syringe. A powder/binder precursor 1310 (e.g., that has been mixed as previously described) is formed into a cylinder 1320. The cylinder can be formed by injection molding or melting it into a cylinder shaped mold. The cylinder is then loaded into chamber 1310 equipped with a heater 1340 disposed to heat at least the tip of the chamber proximate to the chamber opening 360. Compression of the syringe barrel 1360 forces the part formed as a cylinder down and into the heated zone where the part can melt and be extruded out of the syringe to make a part 1370. The part 1370 can then be subjected to debinding and sintering as previously described. This method and apparatus can be used for loading any material comprising a thermoplastic such as plastics and foods that can be melted (e.g., chocolate, caramel, fats, icing and fondants) and solidified/molded into a rigid shape.

### EXEMPLIFICATION

### Example 1

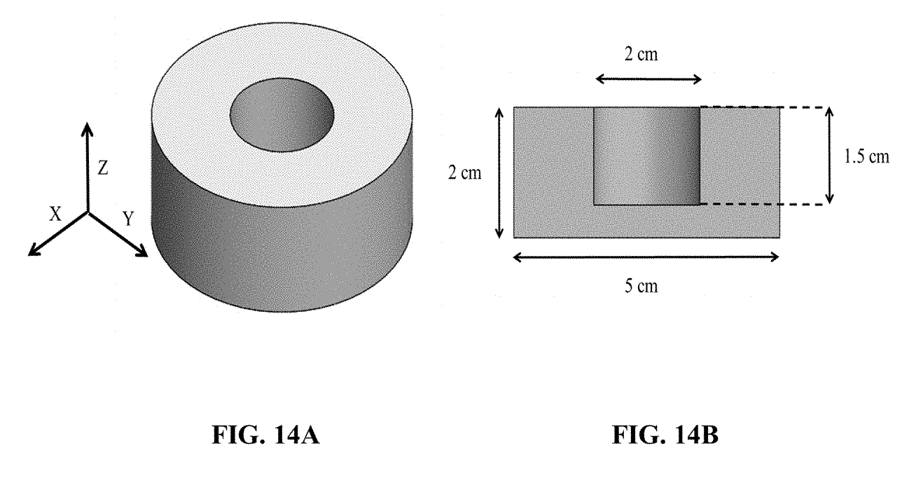

Computer Aided Design was used to design the model shown in FIG. 14A as an isometric projection and 14B as a front cross cut view. The model is for a part having a diameter of 5 cm and a height of 2 cm. The model also featured a hole in the center with a diameter of 2 cm and depth of 1.5 cm. Slicing program Simplfy3D was then used to produce G-code that could be used to print a part based on the model using a Flashforge 3D printer (Flashforge, USA) and red ABS filament

The conditions for printing were:

Extruder: Nozzle diameter 0.4 mm; Retraction distance 1.00 mm; Retraction speed 1200 mm/min;

Layers: Primary layer height 0.2 mm; Top solid layers 3; Bottom solid layers 3; Outline/perimeter shells 2; Outline Direction inside out; First layer height 90%; First layer width 100%; First layer speed 50%; Start point optimize start points for fastest printing speed

Additions: Use skirt/Brim; Skirt layers 1; Start offset from part 4 mm; Skirt outlines 2; Use raft layers; Raft layers 3; Raft outline from part 4 mm; Separation distance 0.1 mm; Raft infill 85%;

Infill: Internal fill pattern rectilinear; External fill pattern rectilinear; Interior fill percentage 20%; Outline overlap 20%; Infill extrusion width 100%; Minimum infill length 5 mm; Print sparse infill every 1 layers; Infill angle offsets 0 degree; angle 45 and −45 degree;

Support: none;

Temperatures for print: Extruder 230 degree Celsius; Heated build platform 110 degree Celsius.

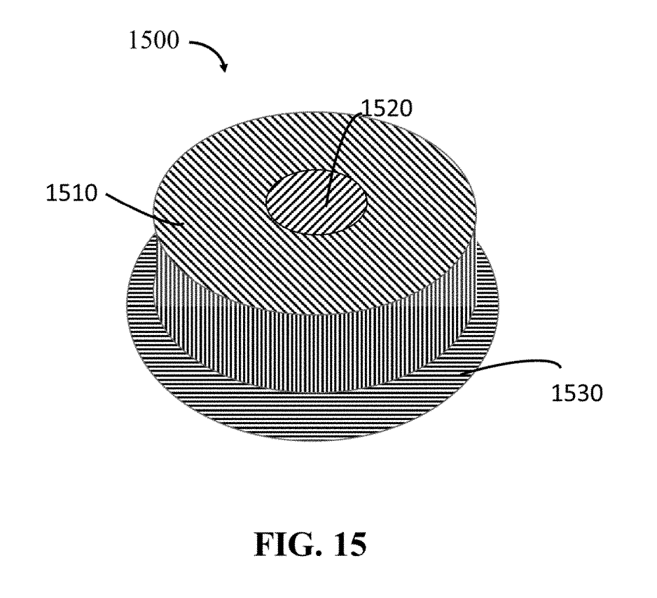

The procedure to create the part was as follows. The designed part was printed oriented as shown by the model in FIG. 13A with X and Y oriented along the built platform and layer by layer upwards in the Z direction. Printing was done until 10 mm upwards was reached and the print was paused. The partial part with the hole (container) in the center was filled with a 2 part epoxy (Devcon® home; ITW, Solon, Ohio) that had been thoroughly mixed just prior to it being used. The container can be filled using a static inline mixer to mix the two parts and a syringe pump to drive the plunger and mixed material into the hole. The nozzle tip can be placed above the hole while filling, for example fixed to the carriage of the Flashforge print head. No movement of the nozzle tip is needed since the 2 part epoxy flows into the container and levels easily. The partial part with epoxy was allowed to cure while maintaining the temperature of the heated bed at print temperature for 2 hours. After this time additional layers of the part were printed up to 15 cm. The epoxy was added on top of the cured epoxy to fill the hole and this was allowed to cure for 15 min. The final 5 cm of the part were printed and epoxy was filled in the hole. The part was then taken off the build platform and allowed to cure for an additional 30 min. This produced ABS/epoxy composite part 1500 shown in FIG. 15, with ABS portion 1510 and epoxy portion 1520. A raft portion 1530, made with ABS, can be removed from the part. The part is considered fully cured after about 24 hours. Fully curing between fillings with epoxy is not required since the ABS part contained the epoxy precursor.

### Example 2

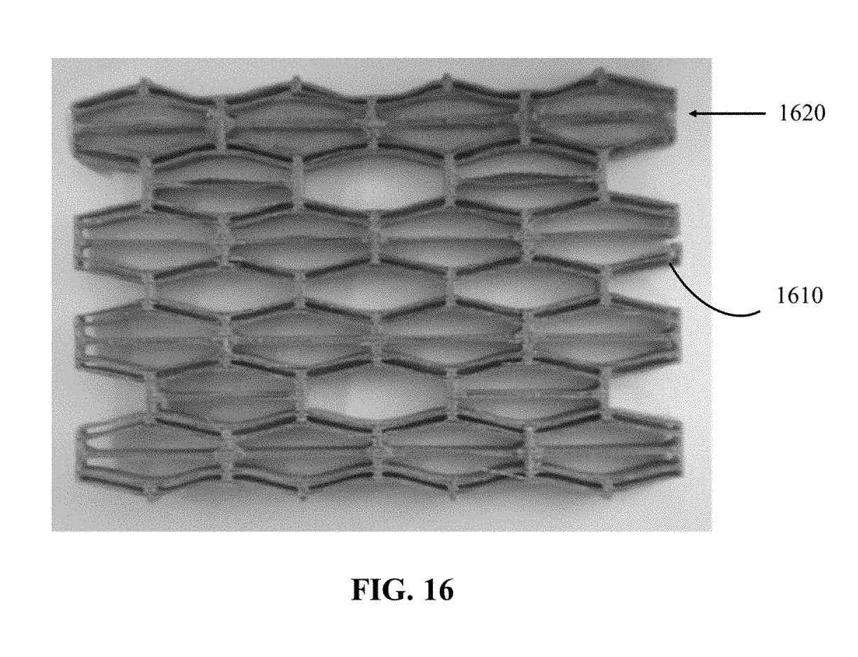

FIG. 16 shows a part that can be made by the methods described herein. The part consists of negative stiffness honey comb 1610 that has one row 1620 filled with polydicylcopentadiene (p-DCPD). The honeycomb is made by 3D printing of ABS under conditions similar to those in example 1. The p-DCPD is made by mixing dicyclopentadiene (DCPD) at >40 degree Celsius and ROMP catalyst ((1,3-Bis(2,4,6-trimethylphenyl)-2-imidazolidinylidene)dichloro(phenylmethylene)(tricyclohexylphosphine)ruthenium, Aldrich Cat no 569747), in a ratio of 6.8 mg catalyst to 50 mL DCPD. Iterations of printing honeycomb and filling with DCPD+catalyst can produce the part.

### Example 3

A 3D printer was constructed using a 30×50 CNC mill having Nema 23 motors coupled to direct drive screw linear actuators for X, Y, and Z movement of the printing head above a stationary stage. The printing head consisted of a Nema 17 direct screw drive linear actuator designed for holding syringes. CNC control was provided by a RUMBA Motherboard which features an ATmega2560 with 3D printer outputs such as Pololu pin compatible stepper drives, heated bead and heated extruder outputs. The board was flashed with Marlin software adapted for the syringe extruder.

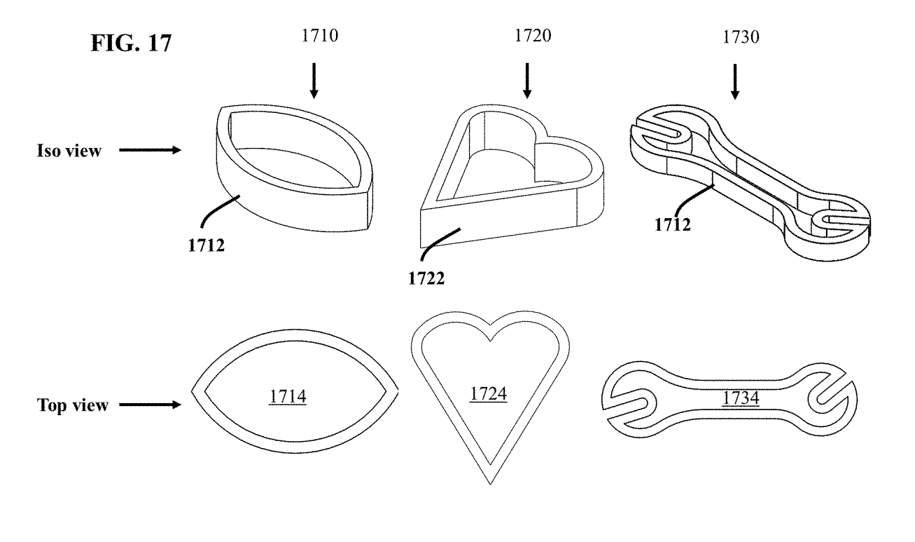

Various shapes, shown in FIG. 17 were designed and are shown in iso and top view. The shapes are of a football 1710, a heart 1720 and a wrench 1730. All cover about an area of about 25 cm² and had walls 1712, 1722, and 1732 0.5 cm thick and 2 cm tall. The shapes had no bottom or top.

A paste was made by mixing rice flour, xanthan Gum and water in a 11:1:8 ratio by volume using a food blender. The paste was loaded into a 60 mL syringe and mounted into the print head of the 3D printer. The shapes shown in FIG. 17 were printed using the 3D printer onto a baking sheet. The printed object provided a container with the baking sheet as a bottom walls 1714, 1724 and 1734, and the rice paste as the side walls. Each object was filled with a chocolate batter up to about 1 cm and then baked. The baked object retained the shape of the printed rice paste. The rice paste was removed providing a baked item in the shape of a football, a heart and a wrench.

### Example 4

A wrench as described in Example 3 was printed. The shape was filled with a two part epoxy and allowed to set overnight. The rice paste was removed by washing with water providing a wrench made of epoxy. Addition of amylase enzyme and gentle heating (e.g., at about 40-70 degrees Celsius) in the water can facilitate the removal of the starchy paste.

### Example 5

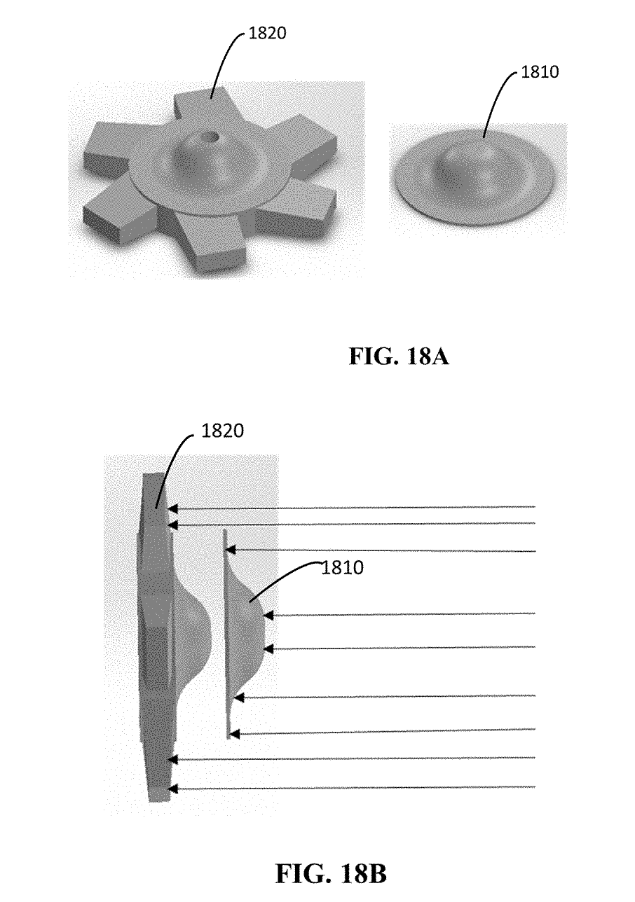

Masks made out of high temperature silicones and useful for protecting parts during shot peening can be produced using 3D printing methods. A mask 1810 for part 1820 are shown in FIG. 18A. The mask can be produced using a syringe extruder to print the part from a high temperature curable silicone Machbloc™ (Tapeworks, Inc). The viscosity of this material is expect to be more than about 100 million cP at 20 degrees Celsius. The mask was cured at 125 degrees Fahrenheit for 30 min in an oven. Curing can be also done while printing the part. A support material such as ABS in the shape of the part can be used and then removed. FIG. 18B depicts the shot peening process with the mask protecting the portion of the part that should not be abraded. In practice, the mask would be in contact with the part and is shown in this blown up version for more clarity. The arrows show the movement of particles during the shot peening process.

Other than in the examples herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (e.g., end points may be used). When percentages by weight are used herein, the numerical values reported are relative to the total weight.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for producing an object using a 3D printer, the method comprising;
a. printing a first portion of the object onto a 3D printer surface, the first portion of the object comprising a first food material, and the first portion of the object defining at least a portion of at least one container having at least one wall, a floor and an opening,
b. depositing a liquid through the opening of the at least one container, the liquid comprising a second food material.

2. The method of claim 1, wherein the container defines a liquid fillable volume.

3. The method of claim 2, wherein the liquid has a volume which is less than about the liquid fillable volume.

4. The method of claim 1, wherein at least one portion of the container comprises the 3D printer surface.

5. The method of claim 4, wherein at least a portion of the floor of the container comprises the 3D printer surface.

6. The method of claim 1, wherein the 3D printer surface can be removed from the 3D printer.

7. The method of claim 1, wherein the container floor comprises the first food material.

8. The method of claim 1, wherein the liquid takes the shape of the container after being deposited through the opening.

9. The method of claim 8, wherein the container retains structural integrity while the liquid takes the shape of the container.

10. The method of claim 1, wherein printing the first portion of the object comprises extruding the first food material through a first nozzle, and depositing a liquid comprises extruding the liquid through a second nozzle.

11. The method of claim 1, further comprising curing the liquid to form an at least partially cured liquid.

12. The method of claim 11, wherein curing the liquid to form an at least partially cured liquid is initiated prior to depositing the liquid through the opening of the at least one container.

13. The method of claim 11, wherein curing comprises heating the liquid.

14. The method of claim 11, wherein the container maintains its structural integrity while the liquid is cured.

15. The method of claim 11, wherein curing is initiated by energy from an energy source selected from the group consisting of a resistive heater, an electron gun, a UV lamp, a visible light lamp, an IR lamp, a chemical reaction, a laser and combinations thereof, and wherein the energy source directs energy at the liquid.

16. The method of claim 11, further comprising removing the object from the 3D printer surface prior to curing.

17. The method of claim 11, wherein the liquid is at least partially cured while the object is disposed on the 3D printer surface.

18. The method of claim 1, further comprising heating the first portion of the object prior to depositing the liquid through the opening.

19. The method of claim 1, further comprising;
a. printing a second portion of the object, the second portion of the object comprising a food material selected from the group consisting of the first food material and a third food material, and the second and first portion of the object defines a total liquid fillable volume amount,
b. depositing an addition portion of liquid through the opening of the container, the additional liquid comprising a food material selected from the group consisting of the second food and a fourth food material, and the liquid and additional liquid providing a sum of liquid volume deposited through the opening of the container.

20. The method of claim 19, wherein the total liquid fillable volume amount is larger than the sum of the volume of the liquid deposited through the opening of the container.
